(19) United States
(12) Patent Application Publication
(10) Pub. No.: US 2024/0196361 A1
(43) Pub. Date: Jun. 13, 2024

(54) METHOD OF POSITIONING A NODE IN A CELLULAR NETWORK

(71) Applicants: CENTRE OF EXCELLENCE IN WIRELESS TECHNOLOGY, Tamil Nadu (IN); INDIAN INSTITUTE OF TECHNOLOGY MADRAS (IIT MADRAS), Tamil Nadu (IN)

(72) Inventors: Vikram SINGH, Tamil Nadu (IN); Abhijeet Abhimanyu MASAL, Tamil Nadu (IN); Priyanka DEY, Tamil Nadu (IN); Sunil KAIMALETTU, Tamil Nadu (IN); Jeniston Deviraj Klutto MILLETH, Tamil Nadu (IN); Bhaskar RAMAMURTHI, Tamil Nadu (IN)

(21) Appl. No.: 18/549,287

(22) PCT Filed: Mar. 4, 2022
(86) PCT No.: PCT/IN2022/050197

§ 371 Date: Sep. 6, 2023

(30) Foreign Application Priority Data
Mar. 6, 2021 (IN) 202141009458

(51) Int. Cl. H04W 64/00; G01S 5/00; G01S 5/02

(52) U.S. Cl. CPC H04W 64/003; G01S 5/0036; G01S 5/0218; G01S 2205/008

(57) ABSTRACT

The present invention relates to methods of positioning a node in a cellular system. The invention discloses estimation of one or more positioning parameters and determination of inter parameter associations. The one or more positioning parameters for one or more path includes Time of Arrival (ToA), Angle of Arrival (AoA). Angle of Departure (AoD), and Doppler. The present invention also discloses methods of estimation of positioning parameters using beam direction and channel estimation. The invention further discloses a method for calibration of antenna, clock and hardware offsets. The present invention discloses methods of prediction of guard bands for utilization of contiguous frequency bands for estimation of channel. The methods of beam prediction and beam tracking. One or more of these methods may be used for positioning the user equipment.

### FIELD OF THE INVENTION

The present invention relates to cellular network, and more particularly to position a device in a cellular network.

### BACKGROUND OF THE INVENTION

Positioning, also called localization, is an important service in fifth generation (5G) New Radio (NR) enabling determining location of a User Equipment (UE). Positioning is necessitated in various important use-cases related to remote driving. Industry-4.0, and remote surgery. Fields like navigation and emergency services especially require positioning accuracy of a few meters for most of the UEs. On the other hand, safety critical applications demand sub meter accuracy, such as industrial internet of thing (IIoT) scenarios requires few decimeters accuracy and vehicle to everything (V2X) requires precision of position estimates up to few centimeters. 5G networks can achieve these accuracies owing to large bandwidth of reference signals, massive number of antennas at the base station (BS), dense deployments and advanced algorithms. 5G enables a device to achieve better accuracy in positioning compared to global positioning systems (GPS) especially for indoor scenarios. In turn, positioning enables the optimization of network functions such as mobility management function, beam-management, channel quality indicator (CQI) prediction and resource optimization.

The release 16 of 5G-NR support positioning methods is based on timing, angle, and power measurements. The UL-TDOA, DL-TDOA and M-RTT are time of arrival (TOA) and time difference of arrival (TDOA) based positioning methods. On the other hand, downlink angle of departure (DL-AOD) and uplink angle of arrival (UL-AOA) uses the angle of departure and angle of arrival of BS with respect to the target UE for locating the target UE. The accuracy of the timing-based methods is limited by bandwidth of the reference signal and accuracy of angle-based positioning. AOD and AOA, depends on the number of antennas at the transmitter (Tx) and receiver (Rx), respectively. The other component that affects the accuracy of the estimates is the estimation algorithms and most of the algorithms trade off precision with complexity.

FIG. 1 illustrate an architecture and interface for positioning in 5G, in accordance with prior art. The positioning of a target UE (102) is triggered based on the request made to the location management server (LMF) (104) which sits in the core network (CN) and interfaces with the NG-RAN via access and mobility function (AMF) (106). The positioning request is generated by one of the networks, target UE, or any external agent (108). The LMF (104) interacts with AMF (106) and NG-RAN via standard interfaces NLs (110) and NRPPa (-NLs-NG-C-) (112) respectively. The server terminates at UE through LPP(a) protocol which is transparent to NGRAN. The NRPPa (112) and LPP(a) enable exchange of necessary information elements between NG-RAN and UE (102), and the server (108), respectively. The 5G positioning architecture also allows positioning a target UE (102) based on ng-cNB via LPP (RRC) (114) protocol for NSA mode. The UE (102) and NG-RAN performs measurements with respect to each other over NR-Uu (116) and LTE-Uu for gNB-TRPs and ng-eNB-TPs in NSA and SA modes, respectively.

FIG. 2 illustrates the positioning procedure in 5G, in accordance with the prior art. At step 204, a LMF 202 establishes connection with the target UE via LPP and with base station via NRPPa. At step 206, the server allocates time-frequency resources to UE and BS for positioning. At step 208, a reference signal is transmitted to the receiver to perform measurement of at least one positioning parameter. The at least one positioning parameter include time based parameters such as time of arrival (ToA), angle based positioning parameters such as angle of arrival from the receiver (AoA(rx)) and angle of departure from the transmitter (AoD(tx)), beam-id, and orientation, power based parameter such as reference signal received power (RSRP), and mobility based parameters such as Doppler, and beam data. The measurements may be for single path (first path or line of sight path (LOS)) or multipath based. Indication for the first path or multipath based measurement may be given by either destination node or the receiver's capability. At step 210, the estimated positioning parameters are reported to a destination node in the cellular network. At step 212, assistance and additional information is reported by both the transmitter and receiver to the destination node. At step 214, the destination node performs positioning. The destination node may be any of LMF, UE and BS.

FIG. 3 illustrates a physical layer transmitter and receiver implementation for positioning, in accordance with prior art. For downlink (DL) based positioning, the LMF provides configurations to the NG-RAN for transmission (or broadcasting) of reference signals and to target UE for measuring the reference signals. Similarly, for uplink (UL) based positioning, the LMF provides resource configurations to the target UE for transmission (or broadcasting) of reference signals and to NG-RAN for measuring the reference signals. The resource configurations provided to the transmitter indicates the parameters for generation and transmission of RS signals, repetition or periodicity of RS resources, transmission filters, and transmission frequency bands etc. The resource configurations for receiver contains one or more of RS-IDs, measurement windows, measurement gaps and frequency bands, and receive filters etc. DL-RS and UL-RS resource allocation is done according to COMB-factor and RE-offset. The COMB factor and RE-Offset allows the receiver to receiver from multiple transmitters simultaneously based of the orthogonality of resources in time and frequency domain. FIG. 4(a) illustrates DL-PRS resource allocation with COMB-12 multiplexing six base stations, in accordance with prior art. FIG. 4(b) illustrates UL-SRS resource allocation with COMB-4, in accordance with prior art. The resources, RS, are used by the receiver to perform the measurements required for positioning the target UE. These measurements can be one or multiple of time (difference) of arrival, angle of arrival, RS received power and angle of departure. Current standards support UL or DL-TDoA, m-RTT, UL-AoA, DL-AOD and ECID methods where the receiver estimates the position of the target UE based on one or multiple of RS time difference (RSTD), RTT, AoA, AoD and RS received power (RSRP) based on measurements reported by UE and RAN. Table 1 provided below illustrates different methods supported by release-16 standards in 5G-NR.

| Methods | UE measurements | RAN measurements | LMF |
|---|---|---|---|
| UL- | — | RSTD | Estimate position based on RSTD |
| TDoA | | | |
| DL- | RSTD from | — | Estimate position based on RSTD |
| TDoA | multiple BSs | | |
| m-RTT | RTT | — | Estimate position based on RTT |
| UL-AoA | — | AoA | Estimate position based on AoA |
| DL-AoD | RSRP/beam | Beam information | Estimate AoDs and use them to |
| | | | estimate the position |
| ECID | RSRP/beam | TA and B-RSRP | Estimate ToAs, AoDs and use |
| | | | them to estimate the position |

Joint estimation methods estimate multiple parameters simultaneously and generate associated parameters using unitary-ESPRIT if estimating 2 parameters and using SSD method if estimating more than 2 parameters simultaneously. However, these methods are computationally complex, requires a lot of memory, transmission overhead and measurement overhead. These methods result in poor accuracy is high mobility scenarios. Individual parameter estimation is computationally simpler, has a small RS measurement and transmission overhead and requires a smaller amount of memory for implementation compared to joint estimation methods. However, it requires additional processing to find the inter-parameter association which can be a difficult task.

The limitations of MUSIC and ESPRIT methods are that it requires large number of antennas at receiver and transmitter to estimate the angle/direction of arrival and angle/direction of departure, respectively. Theoretically the number of antennas should be greater than equal to number of paths i.e., Nₜᵥᵣ>K*L, where minimum value of K is 1 and larger the K, better is the estimation accuracy. However, in many cases, the UE cannot accommodate AAS having larger than 4×4 antenna panels. The estimation of angles is supported based on the beamforming and phase sensing abilities of the base station AASs which can accommodate from 8×8 up to 32×32 antennas arrays.

In cellular positioning, the multipath transmission or non light of sight (NLOS) is a serious bottleneck. If a direct path is completely or partially blocked, the power of light of sight path is low which making the LOS path very difficult to detect in the presence of noise. Practical wireless channel has a high probability of NLOS scenario, and this probability increases with distance and scattering due to density of the environment. In angle of departure-based positioning technique called DL-AoD in 5G-NR, an angle of departure is estimated based on the beam transmitted from the BS and power measured by the UE. In DL-AoD, if the AoD is estimated based on the direction of maximum power received, the accuracy is limited by the number of beams transmitted and the resolution of beam transmission. The large number of transmitted beams may cause huge measurement and reporting overhead which results in high power consumption and higher latency. This technique performs poorly as the measured power contained the contributions from the NLOS paths too. Hence, it is crucial to detect the NLOS scenarios, correct it if possible and to report power corresponding to LoS path alone.

A major drawback with release-16 positioning standards is that the standards are limited in terms of performance. Another drawback with the current standards is their susceptibility to NLOS propagation, calibration errors, misalignment of beams and network synchronization errors. NLOS paths adds bias to the angle measurements (positive or negative bias) and time measurements (positive bias) which degrades the position estimation performance. Moreover, there are other gaps in the standards such as angle measurements using uniform linear arrays is not possible.

Thus, there remains a need for accurate and efficient position estimation methods.

### OBJECTS OF THE INVENTION

A general objective of the present invention is to reduce computational complexity of measurement of at least one positioning parameter.

Another objective of the invention is to reduce pilot and measurement overhead in positioning a user equipment.

Still another objective of the present invention is to improve accuracy of estimation of at least one positioning parameter.

### SUMMARY OF THE INVENTION

The present invention relates to methods of positioning a user equipment in a cellular network. The method may comprise receiving, by a positioning server in a core network, a request for positioning the node from one of the node, a positioning application, and an Access and Mobility Function (AMF). The positioning server may configure a positioning method. An at least one first node may allocate time-frequency resources for reporting at least one positioning parameters for at least one of the multiple paths of a channel based on the positioning method. The at least one first node may transmit at least one RS on an antenna beam. The at least one second node may receive the at least one RS transmitted from the at least one first node. The at least one second node may perform a Channel State Information (CSI) based on at least one of number of antennas at the at least one second node, number of subcarriers, or number of Orthogonal Frequency Division Multiplexing (OFDM) symbols across time. The at least one second node may interpolate the channel at one of the at least one resource element across frequency and at least one resource elements across time, where none of the at least one RS is transmitted. The at least one second node may estimate the values of at least one positioning parameters for the at least one of the multiple paths of the channel. The at least one second node may report the estimated values of the at least one positioning parameters to at least one of the positioning server and the first node in the network. The at least one of the positioning server or the first node may receive assistance information and additional information reported by the at least one first node and the at least one second node. The node is positioned using the at least one positioning parameters, assistance information, and additional information.

In one aspect, the at least one positioning parameters may comprise time positioning parameters and angle positioning parameters. The time positioning parameters may include Time of Arrival (ToA) and transmitter-receiver time difference of arrival, and the angle positioning parameters may include Angle of Arrival (AoA), Angle of Departure (AoD), and Doppler of at least one of a first arrival path and additional paths.

In one aspect, the positioning server may be a Location Management Server (LMF).

In one aspect, the two or more positioning parameters may be jointly estimated using any one of Estimation of Signal Parameters via Rational Invariance Techniques (ESPRIT) or Multiple Signal Classification (MUSIC) algorithms based on a re-dimensioned CSI determined using estimated CSI matrix obtained by reducing one of a dimension comprising of time, frequency and space.

In one aspect, during the estimation of the at least one positioning parameters individually, a node in a cellular network may further perform calculation of a Fourier delay matrix for delay of the at least one of the multiple paths of the channel. A steering angle matrix may be computed for all possible pairs of the at least one angle positioning parameters (AoA and AoD). An association matrix may be computed through a modulus function of a product obtained by pre-multiplication of the steering angle matrix with a time domain re-dimensioned CSI matrix and post multiplication of the product obtained with the Fourier delay matrix. A mapping matrix may be computed based on a dominant absolute element of the association matrix, for establishing a unique association between a time positioning parameter (ToA) and the one or more angle positioning parameters (AoA and AoD). The time positioning parameter (ToA) and the at least one angle positioning parameters (AoA and AoD) may be paired based on the estimated associations.

In one aspect, the node may be one of the first node, the second node, and the positioning server, at which CSI may be available for the estimation at least one of the positioning parameters.

In one aspect, while performing the estimation of the at least one positioning parameters individually, the node may further perform transforming the re-dimensioned CSI into time-domain estimated CSI using an inverse two-dimensional Fourier transformation. A closest time indices in time domain estimated CSI corresponding to the time positioning parameter (ToA) may be selected. A steering matrix may be computed for all possible pairs of the at least one angle positioning parameters (AoA and AoD). An association matrix may be computed through pre-multiplication of the absolute value of the time domain estimated CSI with the steering angle matrix. A mapping matrix may be computed based on a dominant absolute element of the association matrix, for establishing a unique association between the time positioning parameter (ToA) and the at least one angle positioning parameters (AoA and AoD). The time positioning parameter (ToA) and the at least one angle positioning parameters (AoA and AoD) may be paired based on the estimated associations.

In one aspect, computing the mapping matrix may further include iteratively selecting a largest element of association matrix and setting corresponding indices of the largest clement in the mapping matrix to one. The largest element may be selected when any element in a row or a column of the mapping matrix is not already set to one, and the largest element may be skipped for selection of the next largest element when any element in the row or the column of the mapping matrix is already set to one.

In one aspect, the first node and the second node may include the base station, a user equipment, the positioning server, relay node, vehicle-to-everything (V2X) node. transmission reception points (TRP), or repeaters in a cellular network.

In another aspect, the present invention discloses a method for positioning a node in a cellular network. An at least one first node may transmit a reference signal (RS) beamformed on at least one antenna beam. The at least one first node may report a direction in which the at least one beams is transmitted to a destination node. The at least one second node may estimate delay in at least one of the multiple paths of the channel and a corresponding path-power for each of the at least one antenna beams, based on the RS. The at least one second node may report the path delay and the corresponding path-power for each of the at least one antenna beams to the destination node. The destination node may select at least one antenna beams with lowest value of the first arrival path delay. The destination node may determine the at least one antenna beam with lowest value of the first arrival path delay. When the at least one antenna beams with lowest value of the first arrival path delay may be determined to be one, the ToA is a first arrival path delay, AoD is a beam angle, and the path power is a path power, of the selected antenna beam.

In one aspect, the at least one positioning parameters may comprise time positioning parameters and angle positioning parameters. The time positioning parameters may include Time of Arrival (ToA) and transmitter-receiver time difference of arrival, and the angle positioning parameters may include Angle of Arrival (AoA), Angle of Departure (AoD), and Doppler of at least one of a first arrival path and additional paths.

In one aspect, when the at least one antenna beams with lowest value of the first arrival path may be determined to be more than one, an antenna beam with highest path power from the beams with lowest values of the first arrival path is selected. The ToA is the first arrival path delay, AoD is the beam angle, and the first path power is the path power, of the selected antenna beam.

In one aspect, when the number of antenna beams with lowest value of the first arrival path may be determined to be more than one, a weighted average of the number of the antenna beams is used for ToA, AoD and first path power selection. The ToA is weighted average of the first arrival path delays, the AoD is weighted average of beam angles, and the first path power is weighted average of the path powers of the antenna beams.

In one aspect, the destination node may be one of a positioning server, user equipment, base station, relay node, V2X node, repeater, the first node, or the second node, in a cellular network.

In one aspect, the first node and the second node may include a base station, user equipment, positioning server, relay node, vehicle-to-everything (V2X) node, transmission reception points (TRP), or repeaters in a cellular network.

In another aspect, the present invention discloses a method for positioning a node in a cellular network. The at least one second node may estimate a channel based on an at least one reference signal (RS) on at least one beam by at least one first node. The at least one second node may interpolate the channel belonging to each of the at least one beam to obtain the channel for at least one adjacent time-frequency resources where the at least one RS is not transmitted. The at least one second node may compute a power delay profile (PDP) of the channel. The at least one second node may record locations of at least one peak in the PDP. The at least one second node may report a delay and a path power corresponding to the one or more computed peaks in the PDP, to a destination node.

In one aspect, computing the PDP of the channel may further comprise interpolating, by the at least one second node, the PDP around each of the at least one peaks based on adjacent taps in the PDP or based on entire PDP, wherein the at least one second node determines values and the locations of the at least one peaks in the PDP.

In one aspect, the at least one second node may determine and report the value of at least one of a path delay and a path power of a first highest peak in the PDP. The path delay of the first highest peak is a time positioning parameter Time of Arrival (ToA).

In one aspect, the at least one second node may interpolate the channel at a location of one or more path delays for estimation of at least one angle positioning parameters. The at least one angle positioning parameters may be Angle of Arrival (AoA) and Angle of Departure (AoD). The at least one second node may determine and report the value of at least one of the path delay, the path power of at least one peak in the PDP and the at least one angle positioning parameter to the destination node.

In one aspect, the destination node may be one of a positioning server, user equipment, base station, relay node, V2X node, repeater, the first node, or at least one of the second nodes, in a cellular network.

In one aspect, the first node and the second node may be one of a base station, user equipment, positioning server, relay node, vehicle-to-everything (V2X) node, transmission reception points (TRP), or repeaters in a cellular network.

In another aspect, the present invention discloses a method for estimation of a channel in a cellular network. The at least one first node may transmit at least one Reference Signal (RS). The at least one second node may receive multiple adjacent frequency layers across any of same time slot or different time slots. The at least one second node may aggregate the at least one RS across the multiple adjacent frequency layers for estimation of a channel. The least one second node may estimate the channel based on at least one RS aggregated over the multiple adjacent frequency layers. The channel may be interpolated on resource elements in at least one frequency layer where none of the at least one RS is transmitted and performing smoothing of the channel over at least one frequency layer. The channel in frequency domain may be extrapolated in outer resource elements. The at least one frequency layer may be predicted using a Long short-term memory (LSTM) Recurrent Neural Network (RNN).

In one aspect, a contiguous frequency band channel may be utilized for estimation of one or more positioning parameters by at least one of the first node, the second node or a positioning server.

In one aspect, the at least one positioning parameters may comprise time positioning parameters and angle positioning parameters, the time positioning parameters include Time of Arrival (ToA) and transmitter-receiver time difference of arrival, and the angle positioning parameters include Angle of Arrival (AoA), Angle of Departure (AoD), and Doppler of at least one of a first arrival path and additional paths.

In another aspect, a method for positioning a node in a cellular network is described. The at least one positioning server may configure a positioning method and assistance information for LoS confidence detection. An at least one first node may allocate time-frequency resources for reporting at least one positioning parameters for at least one path of the multiple channel paths based on the positioning method. The at least one first node may transmit at least one reference signal on at least one beam. The at least one second node may estimate a path delay and an angle positioning parameters for the multiple channel paths. The angle positioning parameters may be Angle of Arrival (AoA) and Angle of Departure (AoD). The at least one second node may select a path with a minimum value of the path delay as a first arrival path and a corresponding value of the oat least one angle positioning parameters for positioning a node as the value of AoA and AoD of the first arrival path, wherein the first arrival path is a Line of Sight (LoS) path. The at least one second node may report values of the path delay, the at least one angle positioning parameters, and the LoS confidence parameter of each of the multiple channel paths to a destination node.

In one aspect, the LoS confidence parameter may be determined using a misalignment angle between the at least one second node and the at least one first node, and wherein the misalignment angle is an angle offset between the AoD and the AoA of one of the path of the multiple channel path.

In one aspect, the destination node may further determine a link as LoS of NLOS using LoS confidence parameter. The may be is determined as NLOS when the LoS confidence parameter may be present below a threshold value and as LoS when the LoS confidence parameter may be present above the threshold value. The destination node may estimate an NLOS bias per path based on a location of a reflector. The destination node may correct and update the values of at least one of the time positioning parameter and the at least one angle positioning parameters based on the NLOS bias, thereby positioning a node using updated values.

In one aspect, the first node, the second node, and the reference node may be one of the base station, a user equipment, the positioning server, relay node, vehicle-to-everything (V2X) node, transmission reception points (TRP), or repeaters, in a cellular network.

In one aspect, the destination node may be one of the positioning server, first node, and the second node.

In one aspect, the LoS confidence parameter may be one of a one bit value and soft value between zero to one. The value one indicates the link as LoS and zero indicates the link as NLoS.

In another aspect, a method for calibration of antenna, clock, and hardware in a cellular network is described. The positioning server may configure at least one Positioning Reference Node (PRN) with at least one positioning method. An at least one first node may allocate time-frequency resources for reporting at least one positioning parameters for at least one path of multiple channel paths based on the positioning method. The at least one first node may transmit at least one reference signal on a beam to at least one PRN. The at least one PRN may receive at least one reference signal on allocated time-frequency resources transmitted by at least one first node. The at least one PRN may estimate values of at least one positioning parameters. The at least one PRN may compute actual values of the at least one positioning parameters with respect to own location. The at least one PRN may report an estimated value and the actual value of at least one positioning parameters to a destination node. The destination node may calculate an angle offset and a time offset based on an error between the actual value and estimated value of the at least one positioning parameters.

In one aspect, the angle offset and the time offset is one of instantaneous value and average value.

In one aspect, the destination node may provide the angle offset and the time offset as assistance information to a node, thereby correcting the at least one positioning parameters measured in the node using the error calculated between the actual values and the estimated values of the at least one positioning parameters.

In one aspect, the first node and the second node may be one of the base station, a user equipment, the positioning server, relay node, vehicle-to-everything (V2X) node, transmission reception points (TRP), or repeaters, in a cellular network.

In one aspect, the destination node may be one of the positioning server, the first node and the second node.

In one aspect, the one or more positioning parameters may comprise time positioning parameters and angle positioning parameters, the time positioning parameters include Time of Arrival (ToA) and transmitter-receiver time difference of arrival, and the angle positioning parameters include Angle of Arrival (AoA), Angle of Departure (AoD), and Doppler of at least one of a first arrival path and additional paths.

In another aspect, a method of training an Artificial Neural Network (ANN) for positioning a node is described. A location of at least one first node may be generated. Values of at least one positioning parameter may be calculated for the at least one first node, with respect to at least one second node with known location. The location of at least one second node and the calculated values of at least one positioning parameters may be preprocessed for training the ANN. The preprocessed location of at least one second node location and the preprocessed at least one positioning parameters may be input into the ANN. The ANN may learn mapping between all possible locations of the at least one first node, the preprocessed location of the at least one second node location, and the preprocessed at least one positioning parameters. The ANN may be capable of estimating location of the at least first node in the wireless network.

In one aspect, the preprocessing may include maintaining unique one to one mapping between an input and an output and number of outputs is equal to number of at least one second node.

In one aspect, the at least one positioning parameters for at least one paths may include Time of Arrival (ToA), Angle of Arrival (AoA), Angle of Departure (AoD), and Doppler.

In another aspect, a method of beam prediction in a cellular network is described. The at least one second node may preprocess data logs containing at least one of identity of at least one first node (FN-ID), a transmitter beam ID, a receiver beam ID, orientation of the at least one first node, a time stamp, and a position of the first node. The at least one second node may learn a policy function. The at least one second node may compute a conditional joint probability density of the at least one first node being served by the specific beam at a given location, conditioned on the at least one first node (FN-ID), transmitter beam ID, receiver beam ID, orientation of the at least one first node, the time stamp, and the position of the first node, using the leaned policy function. The at least one second node may select an at least one beam for transmitting an at least one reference signal. The policy function may be updated based on the feedback provided by the at least one first node.

In one aspect, the policy function may be based on a probability density of presence of the at least one first node in a particular direction with respect to the at least one second node and the at least one first node being served by a specific beam, using a Markov decision process or Q-neural networks (QNN).

In one aspect, the feedback provided may be at least one of a Reference Signal Received Power (RSRP), Signal to Noise Ratio (SNR), Signal to Interference plus Noise Ratio (SINR), Reference Signal Received Quality (RSRQ), and error in values of at least one positioning parameter.

In one aspect, the at least one positioning parameters may comprise one or more time positioning parameters including Time of Arrival (ToA) and transmitter-receiver time difference of arrival, and one or more angle positioning parameters including Angle of Arrival (AoA), Angle of Departure (AoD), and Doppler of at least one of first arrival path and additional paths.

In one aspect, the first node and the second node may include a base station, a user equipment, the positioning server, relay node, vehicle-to-everything (V2X) node, transmission reception points (TRP), or repeaters, in a cellular network.

In another aspect, a method for beam tracking in a wireless communication system is described. The at least one second node may preprocess a sequential data logs for at least one of identity of at least one first node (FN-ID), a beam ID serving the at least one first node, a time stamp, and a position of the first node. The at least one second node may learn a value function. The at least one second node may compute a conditional probability of the next beam given that at least one current beam of the first node, at least one of FN-ID, a beam-ID of the at least one second node, beam-ID of the at least one first node, orientation of the at least one first node, the time stamp, and position of the at least one first node using the learned value function. The at least one next beam may be selected for transmitting a reference signal. The value function may be updated based on the feedback provided by the at least one first node.

In one aspect, the value function may be probability that at least one first node will be served by a next beam for a current beam, using one of Markov decision process or Q-neural networks (QNN).

In one aspect, the feedback provided may be at least one of a Reference Signal Received Power (RSRP), Signal to Noise Ratio (SNR), Signal to Interference plus Noise Ratio (SINR), Reference Signal Received Quality (RSRQ), and error in values of at least one positioning parameter.

In one aspect, the at least one positioning parameters may comprise one or more time positioning parameters including Time of Arrival (ToA) and transmitter-receiver time difference of arrival, and one or more angle positioning parameters including Angle of Arrival (AoA), Angle of Departure (AoD), and Doppler of at least one of first arrival path and additional paths.

In one aspect, the first node and the second node may include a base station, a user equipment, the positioning server, relay node, vehicle-to-everything (V2X) node, transmission reception points (TRP), or repeaters, in a cellular network.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 illustrate an architecture and interface for positioning a user equipment (UE) in 5G, in accordance with prior art.

FIG. 2 illustrates the positioning procedure in 5G, in accordance with the prior art.

FIG. 3 illustrates a physical layer transmitter and receiver implementation for positioning, in accordance with prior art.

FIG. 4(a) and FIG. 4(b) illustrates DL-PRS resource allocation with COMB-12 multiplexing six base stations and UL-SRS resource allocation with COMB-4 respectively, in accordance with prior art.

FIG. 5 illustrates a flow chart of overall processing at the receiver for positioning of the user equipment, in accordance with an embodiment of the present invention.

FIG. 6 illustrates a high accuracy method for measurement of inter-parameter association, in accordance with an embodiment of the present invention.

FIG. 7 illustrates a power delay profile of a channel between transmitter (with 64 antennas) and receiver (with 1 antenna) for Indoor factory-sparse high scenarios, in accordance with an embodiment of the present invention.

FIG. 8 illustrates a low complexity method of estimation of positioning parameters (ToA and AoD) based on beam direction, in accordance with an embodiment of the present invention.

FIG. 9 illustrates the low complexity method of estimation of positioning parameters (ToA and AoD) based on channel estimation, in accordance with an embodiment of the present invention.

FIG. 10 illustrates realisation of a larger spectrum based on aggregation of channel from the adjacent bands, in accordance with an embodiment of the present invention.

FIG. 11 illustrates a block diagram for multilayer processing and PDP quality enhancement, in accordance with an embodiment of the present invention.

FIG. 12 illustrates multipath transmission from a transmitter, in accordance with an embodiment of the present invention.

FIG. 13 illustrates NLOS bias estimation based on the geometry information, in accordance with an embodiment of the present invention.

FIG. 14 illustrates clock offset estimation between 2 TRPs based on a reference node, in accordance with an embodiment of the present invention.

FIG. 15 illustrates network calibration and synchronization based on reference node or anchor node, in accordance with an embodiment of the present invention.

FIG. 16 illustrates calibrations of antenna, clock and hardware offsets, in accordance with an embodiment of the present invention.

FIG. 17 illustrates detection of anomalous or outlier measurements, in accordance with an embodiment of the present invention.

FIG. 18 illustrates neural network architecture for Hybrid positioning based on imitation learning using 18 BSs, in accordance with an embodiment of the present invention.

FIG. 19 illustrates neural network architecture for hybrid positioning based on imitation learning using 12 BSs, in accordance with an embodiment of the present invention.

FIG. 20(a) and FIG. 20(b) illustrate hybrid positioning method 1 and hybrid positioning method 2, respectively, in accordance with an embodiment of the present invention.

FIG. 21 illustrates a method of learning probability density of a user served by a specific beam, in accordance with an embodiment of the present invention.

FIG. 22 illustrates a method of learning probability density of a user transitioning from one beam to another, in accordance with an embodiment of the present invention.

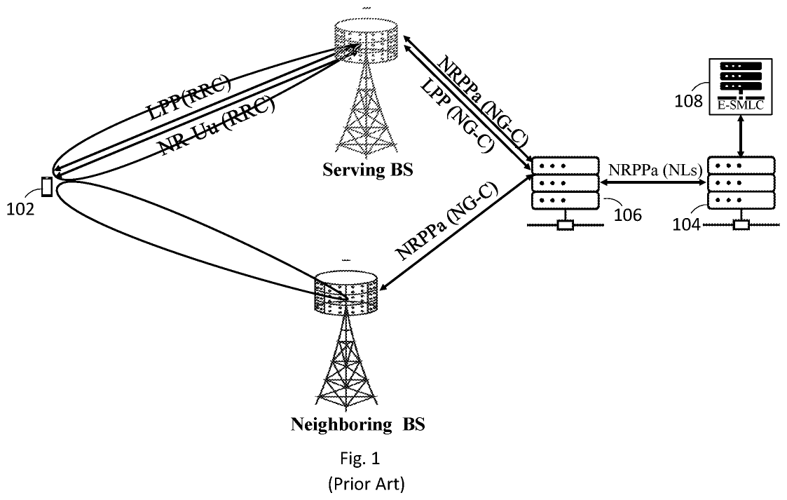

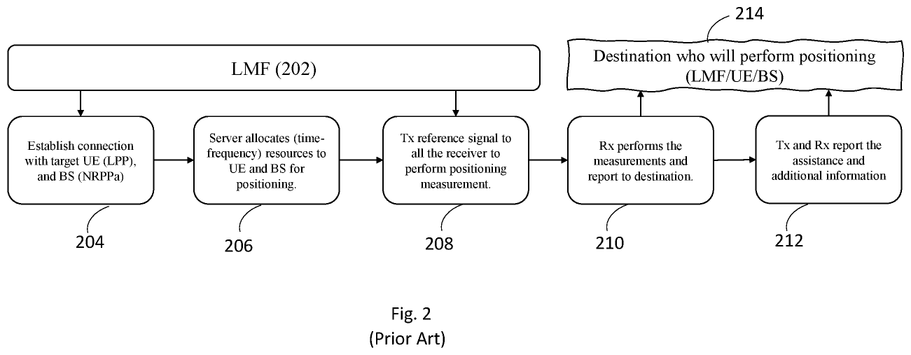

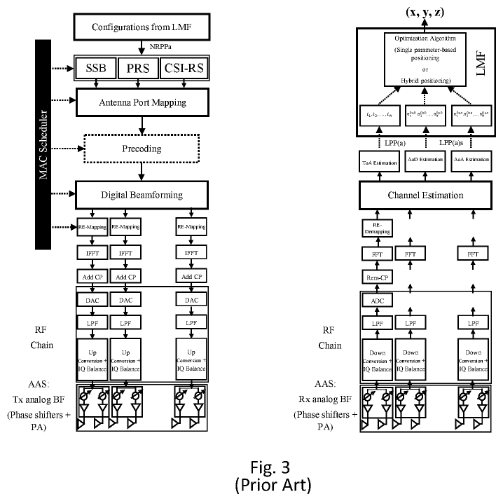

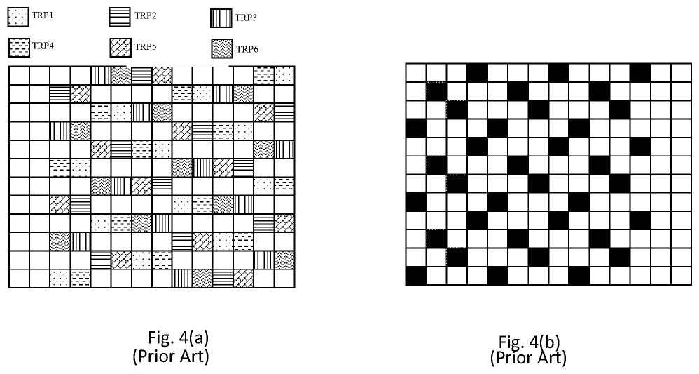

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

The present invention relates to accurate and efficient methods of positioning. The present invention discloses methods of estimation of positioning parameters and determination of inter-parameter associations. The invention also discloses estimation of positioning parameters by one of channel estimation and beam direction. One or more combination of the described methods may be used to measure at least one positioning parameter and improve accuracy of estimation of positioning.

The at least one positioning parameter is measured for determination of a position of a target user equipment. The at least one positioning parameter include mobility parameter such as Doppler of at least one of a first arrival path and additional paths, power-based parameter such as path power, time positioning parameter such as time of arrival (ToA) and transmitter-receiver time difference of arrival, and angle positioning parameters such as angle of arrival (AoA) and angle of departure (AoD). The at least one positioning parameter may be estimated individually or jointly with one another.

At several places throughout the description provided henceforth, a single type of node for example, a user equipment has been described to perform an entire method. It must be noted that other nodes such as a base station, a positioning server, relay node, vehicle-to-everything (V2X) node, transmission reception points (TRP), or repeaters may perform all steps or certain of the method, individually or cumulatively.

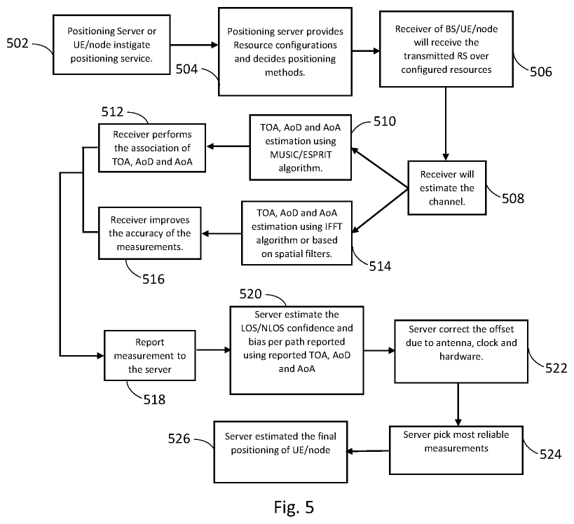

FIG. 5 illustrates a flow chart of overall processing at the receiver for positioning of the user equipment, in accordance with an embodiment of the present invention. As illustrated in FIG. 5, at step 502, the positioning measurements may be instigated by either positioning server, user equipment (UE), an Access and Mobility Function (AMF) or any other node where positioning is to be determined. The request may be processed by a Location Management Server (LMF) in a core network. At step 504, the positioning server may configure a positioning method. Similarly positioning server configures the associated BS to transmit the reference signal to the UE for positioning measurements. At step 506, the receiver may receive a reference signal for channel estimation over configured resources. At step 508. UE or a node configured for positioning receives the signal and performs estimation of the channel. Similarly, the positioning server may provide the list of the measurements to be estimated by the receiver. The receiver may perform the estimation of the one or more positioning parameters by using any one of high accuracy or low power methods. In the high accuracy method, at step 510, values of one or more positioning parameters are determined using MUSIC/ESPIRIT algorithm. At step 512, the receiver performs an association of the one or more positioning parameters. In method utilizing low power, at step 514, the estimation of one or more positioning parameters is performed using inverse Fourier transform technique. At step 516, the receiver improves the accuracy of the values of the estimated positioning parameters. At step 518, the receiver may configure to report either ToA, AoA, AoD individually or combination of them. These parameters can be reported for more than one multipaths as per configured by the positioning server. The positioning server may configure to the receiver and a transmitter to report assistance information and additional information. The assistance information, additional information and positioning parameters may be utilized to position the UE. At step 520, the positioning server may estimate a line of sight confidence parameter in multi path transmissions using the values of one or more positioning parameter. At step 522, the positioning server may correct an offset in the network due to antenna, clock and hardware. At step 524, the positioning server may calibrate the network to remove the offset and may pick a most reliable measurement of one or more positioning parameter. At step 526, the positioning server may estimate the final position of the user equipment or the other node. The methods utilized in the positioning of the user equipment are explained in greater detail in below mentioned description.

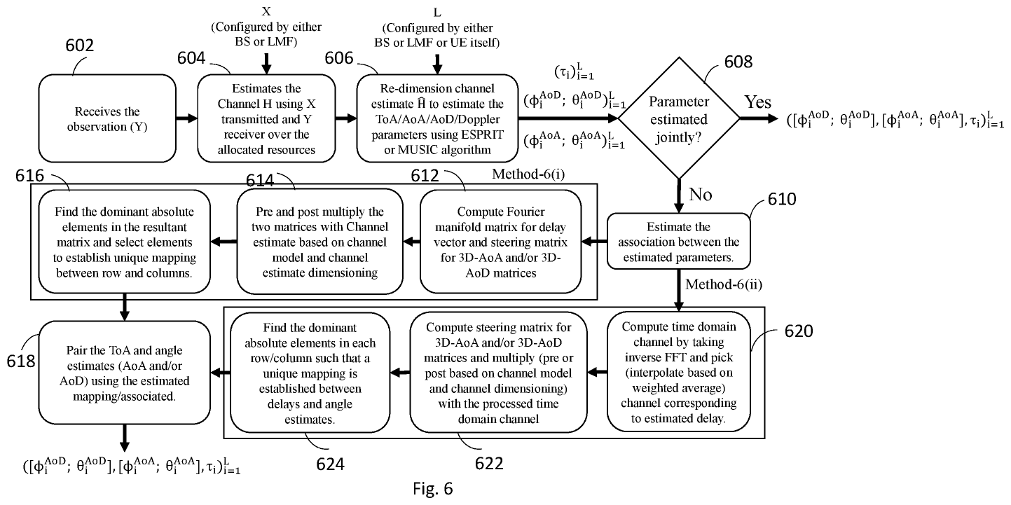

In one embodiment, the receiver may perform estimation of one or more positioning parameters ToA, AoA, AoD and Doppler. FIG. 6 illustrates a high accuracy method for measurement of inter-parameter association. At step 602, the receiver may receive a signal denoted by a first equation,

YC^{N}^{ᵣ}^{×N}^{_{sc}}^{×N}^{_{symb}}

In the first equation. Nᵣ denotes number of antennas at receiver, N_{sc} denotes number of subcarrier and N_{symb} denotes the number of OFDM symbols across time. The received signal Y is used to estimate the channel state information (CSI). Although, Y is sufficient to estimate ToA, AoA, AoD and Doppler, but the following explanations are based on the estimated channel state information (CSI). A transmitter may send a reference signal (X) for channel estimation at the receiver. The transmitter may be a base station or LMF. At step 604, the receiver estimates the channel using the reference signal, or pilot signals, transmitted by the transmitter based on the configurations provided by the positioning server. Furthermore, the channel is interpolated for the resource elements where no reference signal, or pilot signal, is transmitted. The receiver may estimate CSI using X and Y received over the allocated resources. The CSI may be denoted by a second equation,

HC^{N}^{ᵣ}^{×N}^{ₜ}^{×N}^{_{sc}}^{×N}^{_{symb}}

In the second equation, Nᵣ denotes number of antennas at receiver, N_{sc} denotes number of subcarrier, N_{symb} denotes the number of OFDM symbols across time and Nₜ denotes the number of antennas at the transmitter. The joint estimation of ToA, AoA, AoD and Doppler may be performed based on the subspace of \tilde{H}∈ [symbol] ^{N}^{ᵣ}^{N}^{ₜ}^{N}^{_{sc}}^{N×(N}^{_{symb}}^{/N)} which is 2D-matrix form of multi-dimensional matrix H. The number of paths, L, may be estimated based on the significant Eigen values of the correlation matrix \tilde{R}_{H}=E[\tilde{H}\tilde{H}] where E[.] operator is statistical expectation operator.

At step 606, the base station, LMF or UE itself may configure estimation of a re-dimensioned channel. The re-dimensioned matrix \tilde{H} may be used for estimating the ToAs, AoAs, AoDs and Dopplers corresponding to each path and the association between each parameter may be established based on the simultaneous Schur decomposition (SSD). On the similar lines, the joint ToA-AoA-AoD, ToA-AoA, ToA-AoD, AoA-AoD and individual parameters ToA, AoA, AoD and Doppler may be estimated using \acute{H}C^{N}^{ᵣ}^{N}^{ₜ}^{N}^{_{sc}}^{×N}^{_{symb}}, \acute{H}C^{N}^{ᵣ}^{N}^{_{sc}}^{×N}^{ₜ}^{N}^{_{symb}}, [symbol] C^{N}ₜ^{N}^{_{sc}}^{×N}^{ᵣ}^{N}^{_{symb}}, \acute{H}C^{N}^{ᵣ}^{N}^{ₜ}^{×N}^{_{sc}}^{N}^{_{symb}}, \check{H}C^{N}^{_{sc}}^{×N}^{ᵣ}^{N}^{ₜ}^{N}^{_{symb}}, \acute{H}C^{N}^{ᵣ}^{×N}^{_{sc}}^{N}^{ₜ}^{N}^{_{symb}}, \grave{H}C^{N}^{ₜ}^{×N}^{_{sc}}^{N}^{ᵣ}^{N}^{_{symb}}Λ\check{H}C^{N×N}^{ₜ}^{N}^{_{sc}}^{N}^{ᵣ}^{N}^{_{symb}}^{/N} respectively.

The matrices \acute{H}, \acute{H}, [symbol] , \acute{H}, \check{H},\acute{H}, \grave{H}Λ\check{H} are designed by restructuring H. The row dimension, dim₁, captures the information related to parameters of interest and column dimension, dim₂, provides diversity in measurements for subspace estimation. Mathematically, if dim₁>K*LΛK1 then all the parameters can be accurately estimated for all the paths. Higher the value of K, the better is the quality of parameters estimated using super-resolution methods. It was found that value of K equal to 4 is safe value for ESPRIT (Estimation of Signal Parameters via Rational Invariance Techniques) and MUSIC (Multiple Signal Classification) algorithms which estimate the parameters using signal and null or noise space, respectively.

Referring back to step 606, the ToAs, AoAs and AoDs are estimated for each path using either MUSIC or ESPRIT algorithm at the receiver. At step 608, after individual estimation of the one or more positioning parameters, at step 610, an association between the one or more positioning parameters may be established based on snapshot correlation. The estimated CSI is reshaped into a matrix of size NₜNᵣ×N_{sc} and transformed into time domain CSI for further processing. In another embodiment, a method (6(i)) is illustrated. At step 612, a steering vectors are computed for all the, L², possible pairs of AoAs=[azimuth AoAs; elevation AoAs] and AoDs=[azimuth AoDs; elevation AoDs]. And a Fourier vector may be calculated for delay of each path. At step 614, an association matrix may be computed. The association matrix may be the absolute value of time domain CSI matrix pre-multiplied by steering angle matrix and post multiplication with Fourier delay matrix. Mapping matrix helps in estimating the association between time and angle parameters. At step 616, the mapping matrix is computed based on the dominating indices of the association matrix. In this process, the largest element of association matrix is picked, and the corresponding indices are set to 1 in mapping matrix. Subsequently, the next biggest element is selected, and indices are set to one in the mapping matrix provided that any element in the row or the column is not already set to one. However, if it is so, then this element is skipped, and next big element is taken, and the same process is repeated. At step 618, the mapping matrix establishes the one-to-one correspondence between AoAs, AoDs and ToAs. This method is accurate but may have a high computational complexity.

In another embodiment, a trade-off is offered complexity and accuracy by a method 6(ii). At step 620, a time domain channel may be computed by taking the inverse Fourier transformation. The channel may be interpolated based on weighted average and selecting a channel corresponding to estimated delay. A closest time indices in time domain CSI corresponding to the ToAs. This association matrix is computed by taking the absolute value of time selected time domain CSI pre-multiplied by Steering angle matrix. At step 622, a steering matrix for 3D-AoA and/or 3D-AoD matrices may be computed and multiplied (pre or post based on channel model and channel dimensioning) with the processed time domain channel. At step 624, a mapping matrix based on step 616 may be calculated. The method ends at step 618 with the mapping matrix establishing the one-to-one correspondence between AoAs, AoDs and ToAs. Table 2 illustrates the estimation of associations between the measurement of one or more positioning parameters. Table 2 describes method A denoted by method (6(i)) and method B denoted by method (6(ii)).

| Input: | [ϕᵢ^{AoD}; θᵢ^{AoD}]ᵢ₌₁^{L} = (Θᵢ^{AoD})ᵢ₌₁^{L}: Angle of departures of L-paths from the transmitters. | |
|---|---|---|
| | [ϕᵢ^{AoA}; θᵢ^{AoA}]ᵢ₌₁^{L} = (Θᵢ^{AoA})ᵢ₌₁^{L}: Angle of arrivals of L-paths from the transmitters. | |
| | (τᵢ)ᵢ₌₁^{L}: Time of arrival/flight between Tx-Rx. | |
| | H ∈ [symbol] ^{N}^{ᵣ} ^{× N}^{ₜ} ^{× N}^{_{sc}} ^{× N}^{_{symb}}: Estimate of channel between Tx-Rx. | |
| | Nᵣ is number of antennas at receiver, | |
| | Nₜ is number of antennas at transmitter, | |
| | Δf is subcarrier spacing or numerology, | |
| | N_{sc} is number of subcarrier and | |
| | N_{symb} is the number of OFDM symbols, | |
| | transmitting Nₚ pilots/beam where receiver is measuring over N_{B} number of beams, | |
| | Method: method-A/method-B. | |
| | method-A: Accurate but complex method for associations between ToAs, AoAs and AoDs, | |
| | method-B: Simple method for associations between ToAs, AoAs and AoDs. | |
| Output: | Pairing the measurements ([ϕᵢ^{AoD}; θᵢ^{AoD}], [ϕᵢ^{AoA}; θᵢ^{AoA}], τᵢ)ᵢ₌₁^{L} | |
| 1. | Tx transmits the RS: X_{b} (k) ∈ [symbol] ^{N}^{ₜ} ^{×} ^{N}^{ₚ} for k ∈ Comb(offset, factor) and b = 1, 2, . . . , N_{B}. | |
| 2. | Rx receives the RS: (k) = H(k). X_{b} (k) + N(k) | |
| 3. | Estimate H: Ĥ for k ∈ Comb(offset, factor) and interpolate it for the rest of the subcarriers. | |
| 4. | Estimate the ToAs, AoAs and AoDs for each path using \check{H} ∈ [symbol] ^{N}^{_{sc}} ^{× N}^{ᵣ}^{N}^{ₜ}, \acute{H} ∈ [symbol] ^{N}^{ᵣ} ^{× N}^{_{sc}}^{N}^{ₜ}, \acute{H} ∈ [symbol] ^{N}^{ₜ} ^{× N}^{_{sc}}^{N}^{ᵣ} which are re-dimensioned | |
| | versions of Ĥ. | |
| 5. | Compute steering matrix, A, for each pair of AoA and AoD, | |
| | a. | A = [a( [symbol] ₁^{AoD}, [symbol] ₁^{AoA}), a( [symbol] ₁^{AoD}, [symbol] ₂^{AoA}), . . . , a( [symbol] ₂^{AoD}, [symbol] ₁^{AoA}), a( [symbol] ₂^{AoD}, [symbol] ₂^{AoA}), . . . a( [symbol] _{L}^{AoD}, [symbol] _{L-1}^{AoA}), a( [symbol] _{L}^{AoD}, [symbol] _{L}^{AoA})] |
| | | where A ∈ [symbol] ^{N}^{ᵣ} ^{× N}^{ₜ} ^{× L}^{²}, a( [symbol] ᵢ^{AoD}, [symbol] ⱼ^{AoA}) = \dot{a}( [symbol] ⱼ^{AoA})⊗\dot{a}( [symbol] ᵢ^{AoD}) and |
| | | $\dot{a} ( ? ) = \dot{a} ( u ) ⊗ \dot{a} ( v ) , \dot{a} ( u ) = [ 1 , {e}^{- {ik}_{u}} , … , {e}^{- i ( {N}_{u} - 1 ) {k}_{u}} ] , {k}_{u} = \frac{2 π d}{λ} sin ( ϕ ) sin ( θ ) ,$ |
| | | $\dot{a} ( v ) = [ 1 , {e}^{- {ik}_{v}} , … , {e}^{- i ( {N}_{v} - 1 ) {k}_{v}} ] , {k}_{v} = \frac{2 π d}{λ} cos ( ϕ ) sin ( θ ) , if antenna array is aligned in X - Y plane , here$ |
| | | Nᵤand Nᵥ denotes the number of antennas along x and y direction for 2D antenna panel. |
| 6. | Reshape the channel matrix Ĥ to H̅ ∈ [symbol] ^{N}^{ₜ}^{N}^{ᵣ} ^{×} ^{N}^{_{sc}} by converting each time symbol into a vector of dimension NᵣNₜ. | |
| 7. | If Method == method-A: | |
| | a. | Compute the Fourier vectors for each path delay, D = [f(τ₁), f(τ₂), . . . , f(τ_{L})], where |
| | | f(τᵢ) = [1, e^{i2πΔfτ}^{ᵢ}, . . . , e^{2π(N}^{_{sc}}^{-1)Δfτ}^{ᵢ}]. |
| | b. | Γ = \|A^{H}H̅D\|∈ [symbol] ^{L}^{²} ^{×} ^{L} |
| | c. | Normalization of each row of Γ to 1 gives Γ̅. |
| | d. | For each row k = mNᵣ + n find the index of largest $element = {max}_{r} \overline{Γ} ( k , r ) .$ |
| | e. | Ensure that association is 1 to 1 based on value of correlations. |
| | f. | This establishes that [ϕₘ^{AoD}; θₘ^{AoD}], [ϕₙ^{AoA}; θₙ^{AoA}] is associated with τᵣ. |
| | g. | Return ([ϕₖ^{AoD}; θₖ^{AoD}], [ϕₖ^{AoA}; θₖ^{AoA}], τₖ)ᵢ₌₁^{L} and Γ̅ (optional). |
| 8. | If Method == method-B: | |
| | a. | idxSoft = round {[τ₁, τ₂, . . . , τ_{L}/(Δf*N_{sc})}. |
| | b. | ĥ = IFFT_{N}_{_{sc}} (Ĥ) ∈ [symbol] ^{N}^{ₜ}^{N}^{ᵣ} ^{× N}^{_{sc}}. |
| | c. | h̅ = [w₋₁ * ĥ(p(idxSoft) − 1) + w₀ * ĥ(p(idxSoft)) + w₁ * ĥ(p(idxSoft) + 1)]∈ [symbol] ^{N}^{ₜ}^{N}^{ᵣ} ^{× L} |
| | d. | Γ = \|A^{H}H̅\|∈ [symbol] ^{L}^{²} ^{×} ^{L} |
| | e. | Normalization of each row of Γ to 1 gives Γ̅. |
| | f. | For each row k = mNᵣ + n find the index of largest $element = {max}_{r} \overline{Γ} ( k , r ) .$ |
| | g. | This establishes that [ϕₘ^{AoD}; θₘ^{AoD}], [ϕₙ^{AoA}; θₙ^{AoA}] is associated with τᵣ. |
| | h. | Return ([ϕₖ^{AoD}; θₖ^{AoD}], [ϕₖ^{AoA}; θₖ^{AoA}], τᵢ)ᵢ₌₁^{L} and Γ̅ (optional). |

In one embodiment, a high accuracy angle of departure-based positioning techniques is described. The receiver estimates the channel based on the reference signal transmitted by the transmitted for each beam and estimate power delay profile. The transmitted reference signal may be positioning reference signal (PRS), synchronization reference signal block (SSB), sounding reference signal (SRS) etc.

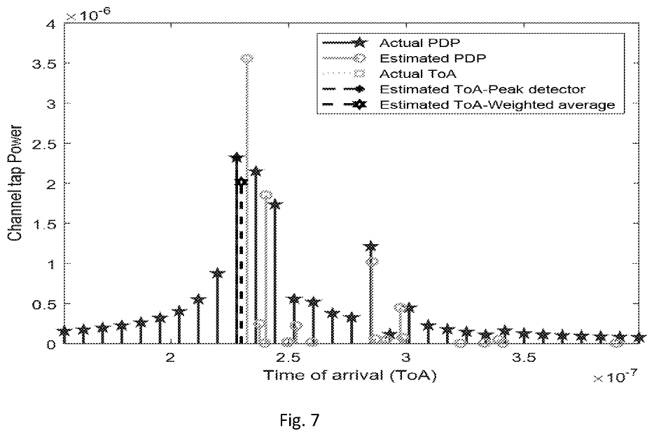

FIG. 7 illustrates a power delay profile of a channel between transmitter (with 64 antennas) and receiver (with 1 antenna) for Indoor factory-sparse high scenarios. As illustrated in FIG. 7, the receiver first finds the first peak in the power delay profile followed by the interpolation of power at a finer granularity between the sample before the peak sample and the one next to the peak sample.

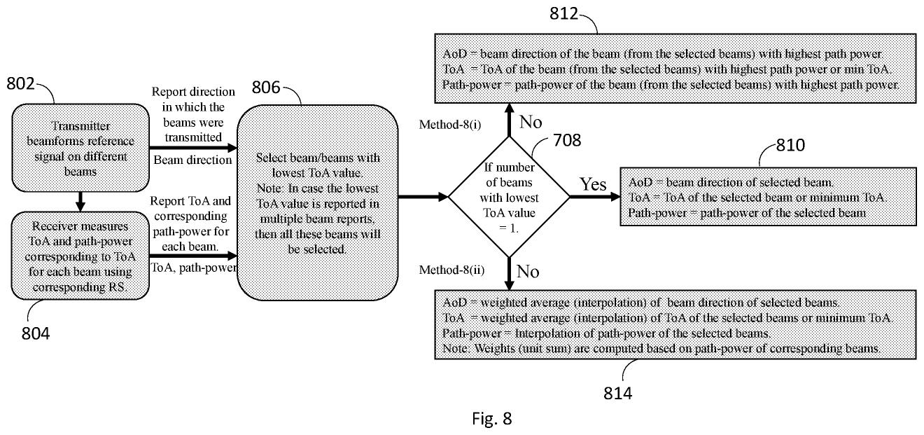

FIG. 8 illustrates a low complexity method of estimation of positioning parameters (ToA and AoD) based on beam direction. The peak of the power delay profile may be considered for the estimation of value of ToA based on the sampling rate. At step 802, a transmitter transmits a reference signal beamformed on one or more beams. The Transmitter reports the direction in which the one or more beams are transmitted to a destination node. The destination node may be a transmitter, receiver or a positioning server. At step 804, the receiver estimates a time positioning parameter (ToA) and the path-power corresponding to the time positioning parameter (ToA) for each of the one or more beams using a corresponding reference signal. The Receiver reports the time positioning parameter (ToA) and the path-power corresponding to the time positioning parameter (ToA) for each of the one or more beams to the destination node. At step 806, the destination node selects the one or more beam with lowest value of the time positioning parameter ToA. At step 808, the destination node determines if the number of beams with lowest value of the time positioning parameter (ToA) is one. If the number of beams with lowest value of ToA is one then at step 810, then the time positioning parameter (ToA), an angle positioning parameter (AoD) and the path power is estimated based on the selected beam. The location server contains, say Pᵣ number of, (Power, ToA, AoD) pairs where the (Power, ToA) is reported by UE and AoD is reported either by the transmitter or the receiver for every beam transmitted. The server sorts the reports in the order of increasing ToA and then selects the pairs with lowest ToA. The AoD of this pair is selected as AoD of LoS path.

FIG. 8 further illustrates a sub-method of estimation of positioning parameters based on beam direction (8(i)). An interpolated channel corresponding to the ToA may be used for AoD estimation. The receiver converts the interpolated channel snapshot into beam domain channel by pre-multiplying it with the oversampled DFT matrix. The AoD is estimated based on the angle, or index, that results in the peak in the power of beam domain channel. An enhanced ToA, power corresponding to the ToA in power delay profile and AoD is reported to the positioning server. Referring back to step 808, in one embodiment, on determination of more than one beams with the lowest value of the time positioning parameter ToA, at step 812, the destination node estimates the time positioning parameter (ToA) for positioning a user equipment based on the ToA corresponding to the beam with highest path power from the selected beams, the angle positioning parameter (AoD) for positioning a user equipment based on the transmit beam direction with highest power from the selected beams, and the path power as the power received on the beam with the highest path power from the selected beams.

FIG. 8 further illustrates a method (8(ii)) of estimation of positioning parameters. In one embodiment, where the receiver does not perform estimation of angle of departure and reports ToA and power to the positioning server, the method (8(ii)) may be used. Referring back to step 808, in one embodiment, on determination of more than one beams with the lowest value of the time positioning parameter (ToA), at step 814, the destination node estimates the time positioning parameter (ToA) for positioning a user equipment based on a weighted average of the ToA of the selected beams, the angle positioning parameter (AoD) for positioning a user equipment based on a weighted average of beam direction of selected beams and, the path power as the interpolation of the path-power of the selected beams. The weights in the weighted average are assigned based on the path-power of corresponding beams. The method (8(ii)) may be used where the positioning server collects the AoD measurements from the transmitter who estimates the AoD either based on the reciprocity or based on the transmit beam directions. The method 8(ii)) often results in better AoD accuracy.

The method of estimation of positioning parameters (ToA and AoD) based on beam direction may be implemented at the transmitter or positioning server provided the CSI information is available at these nodes. Moreover, the method as illustrated in FIG. 8 may be used for any number of antennas at the receiver and transmitter. Further, the method as illustrated in FIG. 8 may be implemented at the server and also at the transmitter, provided the CSI information is available at these nodes. The method as illustrated in FIG. 8 may be extended to estimate the ToA, AoA and AoD of any number of paths that appear in the power delay profile (PDP) of the estimated wireless channel. Table 3 illustrates improved AoD estimation based on weighted average. Table 3 describes method A denoted by method (8(i)) and method B denoted by method (8(ii)).

Input: ([ϕᵢ^{AoD}; θᵢ^{AoD}], powᵢ, τᵢ¹) · ᵢ₌₁^{N}^{_{B}}
ϕᵢ^{AoD}; θᵢ^{AoD} denote the azimuth and elevation angle of departure of the transmit beam-i.
powᵢ denote the power of first tap received by the receiver over the transmit beam-i.
τᵢ¹ denote the ToA of first tap received by the receiver over the transmit beam-i.
Method = method-1: direction/beam from to maximum power received by UE.
Method = method-2: weighted average of the directions having lowest time of flight.
Output: AoD estimates: ([ϕ_{LoS}^{AoD}; θ_{LoS}^{AoD}]).

| 1. | $1 = {max}_{r} {τ}_{r}^{1} .$ | |
|---|---|---|
| 2. | N_{K} = cardinality(I); | |
| 3. | If N_{K}==1 then | |
| | a. | [ϕ_{LoS}^{AoD}; θ_{LoS}^{AoD}]) = [ϕ_{I(1)}^{AoD}; θ_{I(1)}^{AoD}]. |
| | b. | Return [ϕ_{LoS}^{AoD}; θ_{LoS}^{AoD}] |
| 4. | If Method == method-A | |
| | $a . k = {max}_{i} {\{ p o {w}_{i} \}}_{i ∈ I}$ | |
| | b. | Return [ϕₖ^{AoD}; θₖ^{AoD}] |

$5. {w}_{i} = \frac{p o {w}_{j}}{{\sum }_{i = 1}^{{N}_{K}} p o {w}_{i}}$

| | |
|---|---|
| 6. | [ϕ_{LoS}^{AoD}; θ_{LoS}^{AoD}]) = Σᵢ₌₁^{N}^{_{K}} (wᵢ * [ϕᵢ^{AoD}; θᵢ^{AoD}]) ; where Σᵢ₌₁^{N}^{_{K}} wᵢ = 1. |
| 7. | Return [ϕ_{LoS}^{AoD}; θ_{LoS}^{AoD}]. |

The method as illustrated in FIG. 8 is simple and fast and overcomes the challenge of limited accuracy of ToA estimate especially for inverse fourier transformation based ToA estimation which utilizes the estimate of PDP. The accuracy of ToA is limited by bandwidth. Referring back to FIG. 7, due to finite bandwidth the taps expand into sinc pulses and many times close by taps superimposes resulting into larger peaks making it more difficult to segregate them in time domain. This phenomenon, as illustrated in FIG. 7, displaces the peaks and reduces the accuracy of ToA estimates. In such cases, also, the method as illustrated in FIG. 8 utilizing weighted average of peak tap and its adjacent taps based on their power improves the accuracy of ToA estimates.

In another embodiment, a low complexity method of estimation of positioning parameters (ToA and AoD) based on channel estimation. A channel is estimated based on the reference signal beamformed by the transmitter. The AoD may be estimated either using the channel estimates available at the receiver or the channel estimates reported to either BS or positioning server. The AoD is estimated using the channel estimates using either ESPRIT or MUSIC algorithm. If the AoD is estimated at the receiver, the receiver reports the power, ToA, and AoD to the positioning server where it is combined with beam information reported by the transmitter to refine the AoD estimates. In another scenario, the positioning server may process the CSI estimates and beam information, reported by the transmitter, together to estimate the AoD precisely.

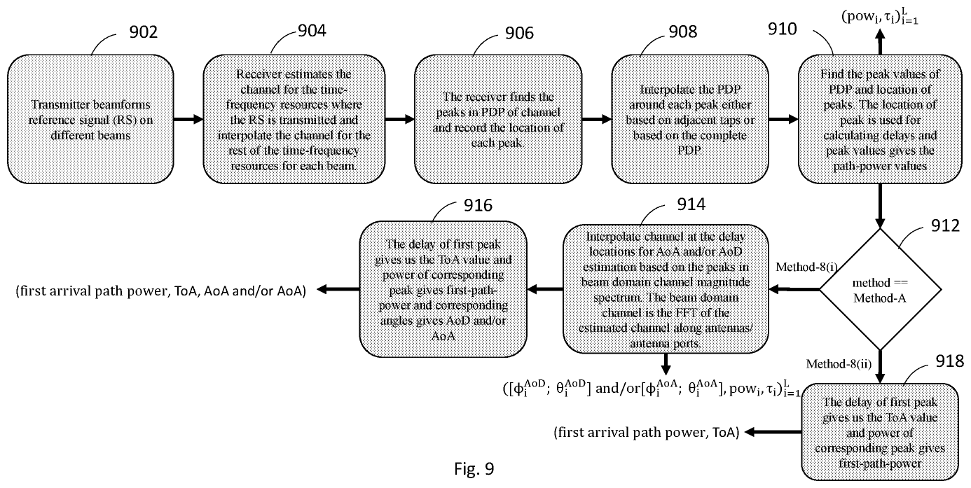

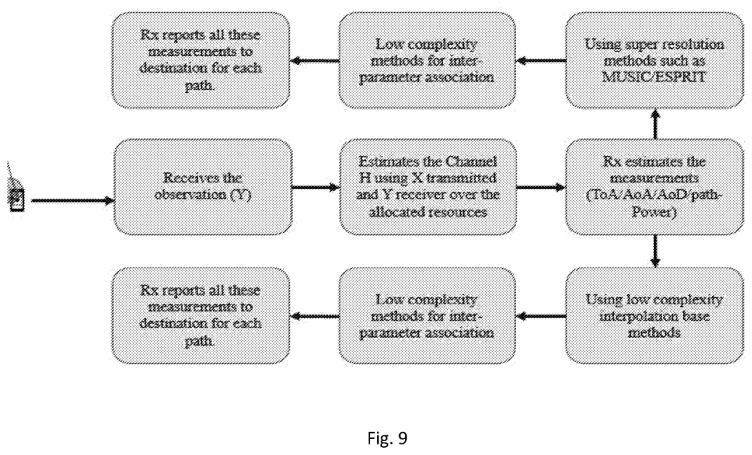

FIG. 9 illustrates the low complexity method of estimation of positioning parameters (ToA and AoD) based on channel estimation. As illustrated in FIG. 9, at step 902, the transmitter beamforms a reference signal on different beams to the receiver. At step 904, the receiver estimates a channel based on a reference signal received on the allocated time-frequency resources and interpolates the channel for the time-frequency resources where the

RS is not transmitted for each beam. At step 906, the receiver finds and records location of cach peak in the power delay profile (PDP) of the channel. At step 908, the receiver interpolates the PDP around each of the one or more peaks based on adjacent paths or based on the entire PDP. At step 910, the receiver determines the values and the locations of the one or more peaks in the PDP. The values of the peaks are used for determination of path-power and the location of the one or more peaks is used for calculation of delay.

In another embodiment, a method (9(i)) is utilized. At step 912, it is determined by the receiver if the method (9(i)) is to be performed. If yes, then at step 914, the receiver interpolates a channel at the delay locations for one or more angle positioning parameters AoA and AoD estimation based on the peaks in a beam domain channel magnitude spectrum. The beam domain channel is a Fourier transformation of the estimated channel along one or more antenna ports. At step 916, the positioning server for estimation of a time positioning parameter ToA based on the delay of first peak, the one or more angle positioning parameters AoA and AoD and first path-power based on the power of corresponding peak. In another embodiment, a method (9(ii)) is described wherein, at step 918, the positioning server estimates time positioning parameter ToA based on the delay of first peak and the first path-power based on the power of corresponding peak. The server processes the CSI estimates and beam information, reported by the transmitter, together to estimate the AoD precisely. Table 4 illustrates a method based on AoD estimation and improved ToA estimation based on inverse fourier transformation (IFFT). Table 4 describes method A denoted by method (9(i)) and method B denoted by method (9(ii)).

| Input: | Tx have Nₜ antennas, | |
|---|---|---|
| | Rx have Nᵣ antennas with ODFM system having N_{sc} subcarriers, | |
| | transmitting Nₚ pilots/beam where receiver is measuring over N_{B} number of beams, | |
| | Method: method-A/method-B. | |
| Output: | ToA estimate, Power estimate, AoD estimates: ([ϕ_{LoS}^{AoD}; θ_{LoS}^{AoD}]). | |
| 9. | Tx transmits the RS: X_{b}(k) ∈ [symbol] ^{N}^{ₜ} ^{× N}^{ₚ} ƒ or k ∈ Comb(offset, factor) and b = | |
| | 1, 2, ..., N_{B}. | |
| 10. | Rx receives the RS: Y(k) = H(k)·X_{b}(k) + N(k) | |
| 11. | Estimate H: Ĥ for k ∈ Comb(offset, factor) and interpolate it for the rest of the | |
| | subcarriers. | |
| 12. | ĥ = IFFT_{N}_{_{sc}} (Ĥ) ∈ [symbol] ^{N}^{_{SC}} ^{× N}^{ₜ}. | |
| 13. | p = Findpeak (\|\|ĥ\|\|²), where p is vector containing peaks in the power delay | |
| | profile and norm is taken antenna dimension. | |
| 14. | ToA = (w₋₁ * (p(1) − 1) + w₀ * p(1) + w₁ * (p(1) + 1))/(N_{sc} * | |
| | Numerlogy), | |
| | | where w₋₁ + w₀ + w₁ = 1. |
| 15. | Pow = (interpolate (\|ĥ\|²) at w₋₁ * (p(1) − 1) + w₀ * p(1) + w₁ * (p(1) + 1)) | |
| 16. | If Method == method-A | |
| | c. | AoD = Findhighestpeak{FFT_{N}_{ₜ}[w₋₁ * ĥ(p(1) − 1) + w₀ * |
| | | ĥ(p(1)) + w₁ * ĥ(p(1) + 1)]} |
| | d. | Return (ToA, Pow, AoD). |

| | |
|---|---|
| 17. | Return (ToA, Pow). |

In another embodiment, the positioning reference signals are transmitted in uplink or downlink for estimation of location. One of the estimates of the time of arrival, angle of arrival and angle of departure is made using channel estimates which may be used for estimating PDP. If LoS path is not blocked then first non-zero tap in PDP gives the information about ToA, AoA and AoD of the direct path. The accuracy of these parameters depends on the quality of estimated PDP. The reference signals are transmitted with COMB pattern. This results in holes, where no pilot is transmitted resulting in unavailability of channel estimate for those frequency, in RE along frequency domain in an ODFM symbol. The frequency domain resource element (RE) holes cause the spreading of the taps in time domain. Hence it is crucial to interpolate the channel for internal unknown REs and extrapolate for outer REs in frequency domain. This results in better ToA, AoA, and AoD estimates compared to raw channel estimation-based method i.c. without interpolation. The ToA estimation error is a function of reference signal bandwidth. In many cases, it is difficult to allocate contiguous frequency bands or Bandwidth Parts (BWP) or frequency layers (multiple BWPs) which reduces the overall bandwidth.

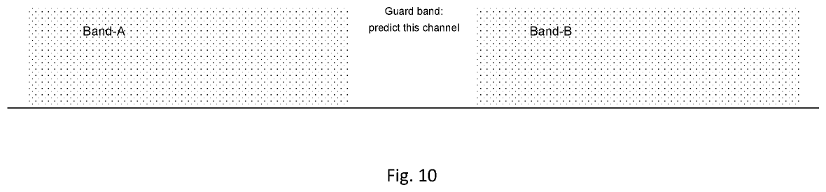

FIG. 10 illustrates realisation of a larger spectrum based on aggregation of channel from the adjacent bands. Prediction of a guard band between two frequency band may allocate contiguous frequency bands. The prediction may be made by deploying a machine learning technique. FIG. 11 illustrates a block diagram for multilayer processing and PDP quality enhancement, in accordance with an embodiment of present invention. A Transmitter transmits a reference signal in uplink or downlink for estimation of a channel. A receiver receives multiple adjacent frequency layers of a channel across different time slots in the same frequency band. At step 1102, the receiver aggregates multiple adjacent frequency layers of the channel in a band. At step 1104, the receiver estimates a power delay profile of the channel based on a one or more positioning parameters. At step 1106, interpolating, resource elements in a guard band channel are interpolated where no RS is transmitted in frequency domain of the channel smoothing of missing Crest Factor Reduction (CFR) is performed. The CFR may be smoothed by a Savitzky Golay filter. At step 1108, the channel is extrapolated in frequency domain in outer REs; and a Long short-term memory (LSTM) Recurrent Neural Network (RNN) is deployed for prediction of a guard band. In case the frequency layer has small band gap, the channel is predicted based long short-term memory (LSTM) based recurrent neural networks (RNN). The LSTM works well only when the number of paths in the channel are small (<10). Such channels are common at millimeter, micrometer and InH or InF scenarios. In this case positioning server will configure more than one band for UE to perform the positioning measurements including ToA, AoA, AoD and configure the UE to perform the measurement aggregating these bands. To support above stated method, UE should be able to process multiple layers. In lower end UEs, the frequency layers should be allowed to receive across time/TDD and then aggregate these layers. Once the information, say CSI, is aggregated the receiver estimates the parameters, such as ToA, AoA and AoD, using this information. For server or transmitter-based position estimation, the receiver reports these measurements to corresponding target node. The UE either reports the same measurements for all the contiguous frequency bands or BWP or frequency layers or sends one common report for all the contiguous frequency bands or BWP or frequency layers. Sending a common report is more efficient way of reporting.

The receiver may receive aggregate multiple adjacent frequency layers to increase the effective bandwidth, which helps achieve accuracy targets. In IIoT scenarios, the delay spread is small, resulting in slow variations in the channel's amplitude and phase spectrum. This property is exploited to interpolate the channel in the guard band to improve the time resolution of the estimated power delay profile and yielding better delay resolution of time which improves the ToA, AoA and AoD estimation performance. Similarly, a diversity in received signal is provided to estimate the signal or noise subspace accurately which in turn improves the estimation accuracy

In another embodiment, NLOS bias in multipath transmission may be estimated and corrected. In a cellular network, multipath transmission or non line of sight is a common scenario. In a low and mid-frequency bands of a communication network, it is not possible to mitigate the NLOS bias completely but can surely be decreased by combining the timing (ToA/TDoA), angle (AoA-AoD) and Reference Signal Received Power (RSRP) information.

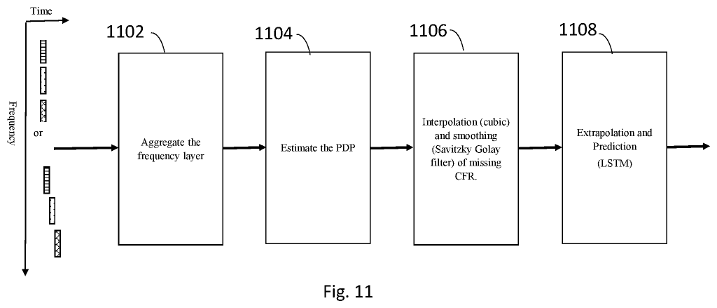

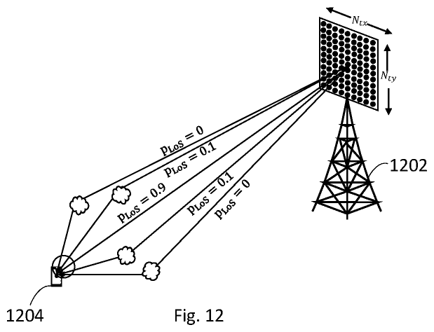

Once ToA and AoA is estimated for each path, the device chooses the ToA with minimum value as the ToA of the direct path and AoA and AoD corresponding to it is taken as the AoA and AoD of the LoS path. The measurements are reported to the destination, say positioning server or the target UE or any other device. The AoD and AoA are used for predicting the state of the link, i.e., whether the link is LoS or NLOS based on the alignment of the AoD and AoA. FIG. 12 illustrates multipath transmission from a transmitter. The transmitter (1202) sends pilot signals to the receiver (1204). The transmitter may be a base station. Each path may have its own path LoS value. Table 5 illustrates a method of link state prediction. The method calculates the misalignment of the angles and scales this value to [0,1] interval using a kernel function. This kernel function is either sigmoid or tan h or rectilinear unit (RELU) function based on application. For example, kernel function can be sigmoid function defined as

$$f ( misalignment ) = \frac{1}{1 + {e}^{β . mislaignment}} ,$$

where β controls the sharpness in transition of the kernel function. Signaling of beam pattern is performed from UE to server.

Input: Tx-AoD = [aAoD; eAoD], Rx-AoA= [aAoA; eAoA].
Output: LoS confidence.

| 1. | Calculate the alignment of angles between Tx and Rx. | |
|---|---|---|
| | a. Azimuth_{misalignment} | = 180 − (aAoA + aAoD) . |
| | b. Elevation_{misalignment} | = 90 − (eAoA + eAoD) . |

| | |
|---|---|
| 2. | Calculate the LoS confidence = ƒ(Azimuth_{misalignment}, Elevation_{misalignment}); where |
| | ƒ is a function such that ƒ(x, y) ∈ [0, 1] for ∀ x and y. |
| 3. | Return LoS confidence. |

If LoS confidence is above a certain threshold (□), the link is classified as an LoS link otherwise is considered the NLOS link. The LoS confidence is also used as a soft value for regression in outlier detection algorithm stated in upcoming section. The NLOS introduces a positive bias in the estimated ToA (=actual ToA+ToA-bias=□+Δ□) which introduce error in localization. If the number of BS having LoS link with the target UE are not enough or have a poor GDOP, then it is not possible to locate the UE with sub-centimeter level accuracy. Hence it is pivotal to estimate the NLOS bias in ToA measurements and/or error in angles to enable high precision localization.

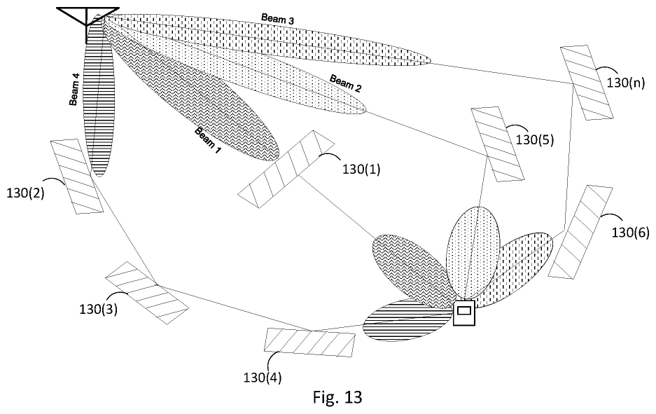

The UEs, BSs, or the positioning server can estimate NLOS ToA-bias and/or angle (AoA and AoD) deviation if the information about the geometry of the environment causing multipath is available. The network can easily collect this information for indoor house (InH) and indoor factory (InF) scenarios where the geometrical objects are classified into fixed and mobile. The network uses the map/geometry of building to extract the location of fixed obstructions. On the other hand, cameras/light detection and ranging (LIDARs)/radio detection and ranging (RADARs) can locate the mobile objects. In case of RADAR, the accuracy of object detection will depend on the frequency of radio waves and size of the objects. The server or transmitter selects the reflector or obstacle in the environment which is closely aligned with multipath angles estimated at the transmitter or the receiver. Based on the location on the reflector the NLOS bias is calculated and then corrected and accordingly the angles are updated. FIG. 13 illustrates NLOS bias estimation based on the geometry information. As illustrated in FIG. 13, 130(1)-130(n) represents LoS blockages. The server updates the reference location to the location of the reflector and uses the updated information for positioning. Table 6 illustrates a method for NLOS bias estimation and correction.

Input: BS-AoD, BS location: p_{BS}, UE-AoA, UE location: p_{UE}, and
location of scatterers= {pᵢ}ᵢ₌₁^{N}} · N = number of scatters.
Given: los confidence < γ , i.e., NLOS propagation
1. For i = 1, . . . , N

| | |
|---|---|
| a. | ϕᵢ^{AoD} = azimuth AoD between BS and scatter-i. |
| b. | θᵢ^{AoD} = elevation AoD between BS and scatter-i. |

$2. k = {min}_{i} ‖ {BS}^{AoD} - [ {ϕ}_{i}^{AoD} ; {θ}_{i}^{AoD} ] ‖ \&\& {TOA}_{i} > \frac{‖ {p}_{B S} - {p}_{i} ‖}{c} .$
3. Update the time of arrival and angle of arrivals.

| $a . {TOA}_{n e w} = TOA - \frac{‖ {p}_{B S} - {p}_{1} ‖}{c} . \backslash \backslash reduces the NLOS ToA - bias$ | |
|---|---|
| b. | p_{ref} = pₖ. |
| c. | aAOD_{new} = 180 − ϕₖ^{AoA}. \\ azimuth angle of departure |
| d. | eAOD_{new} = 90 − ϕₖ^{AoA}. \\ elevation angle of departure |

4. Return TOA_{new}, p_{ref}, AOD_{new} and AOA_{new} for positioning.

Once the location of the reflectors is known, BSs, UEs, or the positioning server calculates the multipath/NLOS distance/time of flight based on azimuth and zenith angle of departure A/ZoD and arrival A/ZoA. This helps in the calculation of NLOS bias or excess delay, but it is possible for single and double order reflections only. Moreover, the higher order reflections are insignificant in most scenarios at least in millimeter wave and micrometer wave propagation scenarios. The accuracy of NLOS bias depends on the selection of the correct reflectors which in turn depends on the density of reflectors/scatterers, accuracy of angle measurements and accuracy of the position of scatters. The accuracy of angle measurements is generally better for BS due to the large size of antenna arrays.

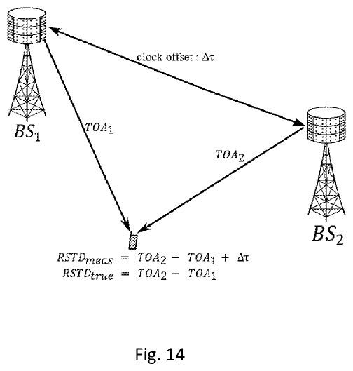

In another embodiment, antenna, clock and hardware offsets in a cellular network may be corrected based on one of an anchor node or a reference node. The accuracy of time and angle information-based positioning methods depend on the precision of these information. Hardware impairment, such as RF chain delays at transmitter and receiver, network asynchronization, and beam misalignment due to mutual coupling between antennas introduces an offset in time of arrival, angle of arrival and angle of departure. The network asynchronization of 50 ns introduces a range error of 15 m and similarly beam alignment error of few degrees introduces the deviation of few meters depending on distance of the UE from the BS. This can affect the positioning accuracy adversely. These impairments are constant for a small duration of time, though, hence can be calibrated. An efficient way to estimate these time and angle offset is based an anchor node or a reference node. FIG. 14 illustrates clock offset estimation between 2 TRPs based on a reference node.

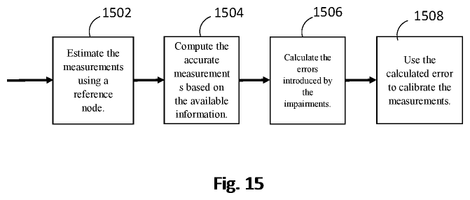

The anchor node is a device whose location is known with high precision and a positioning reference node is fixed node deployed in the network whose location is exactly known. FIG. 15 illustrates network calibration and synchronization based on reference node or anchor node. At step 1502, the reference node either estimates the ToA, AoA, and AoD or report the measurements on the allocated resources and report it to server or BS. At step 1504, accurate information is measured based on available information. At step 1506, as location of this node is known, server calculates angle and time offset using the actual time of arrival, angle of arrival and angle of departure with respect to the BS locations. At step 1508, the calculated error is used to calibrate the measurements. Server provides these offsets as assistance information to other UEs. Table 7 illustrates Inter-BS clock offset estimation.

| Input: | location of i^{th} BS: pᵢ^{BS}, reference/anchor UE location: p_{ref}^{UE}, and | |
|---|---|---|
| | TOA measured by reference UE with respect to each BS. | |
| | TOA measured by each UE with respect to each BS. | |
| Given: | c = speed of light. | |
| 1. | For i = 2, . . . , N_{BS} // consider 1^{st} BS as reference BS. | |
| | a. | RSTDᵢ^{meas} = TOAᵢ − TOA₁. |
| | $b . {RSTD}_{i}^{t r u e} = \frac{‖ {p}_{i}^{B S} - {p}_{ref}^{U E} ‖}{c} - \frac{‖ {p}_{1}^{B S} - {p}_{ref}^{U E} ‖}{c} .$ | |
| | c. | Δτᵢ = RSTDᵢ^{meas} − RSTDᵢ^{true}: time offset between BS-i and |
| | | BS-1. |
| | $d . {θ}_{i}^{true} = {tan}^{- 1} ( \frac{{z}_{i}^{B S} - {z}_{ref}^{U E}}{\sqrt[2]{{( {x}_{i}^{B S} - {x}_{ref}^{UE} )}^{2} + {( {y}_{i}^{B S} - {y}_{ref}^{UE} )}^{2}}} )$ | |
| | $e . {ϕ}_{i}^{t r u e} = {tan}^{- 1} ( \frac{{y}_{i}^{B S} - {y}_{r e f}^{U E}}{{x}_{i}^{B S} - {x}_{r e f}^{U E}} )$ | |
| | f. | Δθᵢ = θᵢ^{meas} − θᵢ^{true}: elevation angle offset for both AoA and |
| | | AoD. |
| | g. | Δϕᵢ = ϕᵢ^{meas} − ϕᵢ^{true}: azimuth angle offset for both AoA and |
| | | AoD. |
| 2. | For i = 2, . . . , N_{UE}. | |
| | | For j = 2, . . . , NBS // consider 1^{st} BS as reference BS. |
| | a. | RSTDⱼⁱ = TOAⱼⁱ − TOA₁ⁱ − Δτⱼ. |
| | b. | θⱼⁱ = θⱼⁱ − Δθⱼ: offset correction for both AoA and AoD. |
| | c. | ϕⱼⁱ = ϕⱼⁱ − Δϕⱼ: offset correction for both AoA and AoD. |

| | |
|---|---|
| 3. | Perform positioning based on corrected parameter values. |

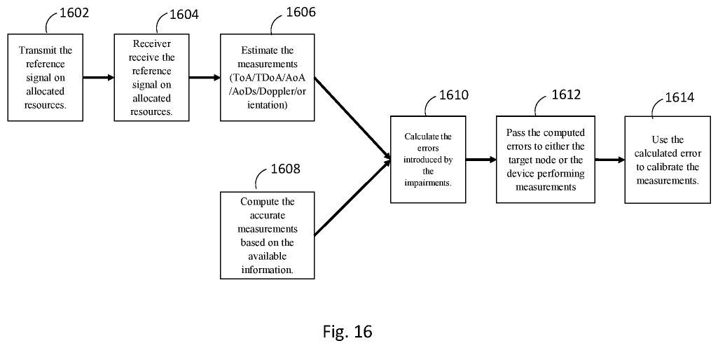

FIG. 16 illustrates calibrations of antenna, clock and hardware offsets. At step 1602, transmitter sends a reference signal. At step 1604, the receiver receives the reference signal on allocated time-frequency resources. At step 1606, the receiver estimates a one or more positioning parameters using one of a reference node or anchor node. AT step 1608, the receiver computes the actual values of the one or more positioning parameters with respect to location of the reference node or anchor node and available information. At step 1610, the positioning server, receiver or a target node calculates an angle offset and a time offset based on an error between the actual and estimated values of the one or more positioning parameters. At step 1612, the calculated error is passed to one of a User Equipment (UE) or receiver for performing measurements. At step 1614, the calculated error is used for calibration of antenna, clock and hardware present in UEs in a communication network based on one of a reference node or anchor node.

In one embodiment, while positioning a UE, the server engages multiple BSs for either transmission or reception of reference signals. The receiver reports the measurement to the server who it uses to compute the position of the target UE. Some of these measurements

$Objective : {argmin}_{( x , y , z )} {\sum }_{n = 1}^{{N}_{BS} - 1} \frac{1}{{σ}_{n o}^{2}} {( c * ( {τ}_{n} - {τ}_{0} ) - \sqrt{{( {x}_{n} - x )}^{2} + {( {y}_{n} - y )}^{2} + {( {z}_{n} - z )}^{2}} + \sqrt{{( {x}_{0} - x )}^{2} + {( {y}_{0} - y )}^{2} + {( {z}_{0} - z )}^{2}} )}^{2}$

| | | |
|---|---|---|
| Subject to: | ${\sum }_{n = 0}^{{N}_{BS} - 1} [ \frac{{( {\hat{ϕ}}_{n} - {ϕ}_{n} )}^{2}}{2} + \frac{{( {\hat{θ}}_{n} - {θ}_{n} )}^{2}}{{σ}_{n 0}^{2}} ]$ where | ${θ}_{n} = \{ \begin{matrix}{tan}^{- 1} ( \frac{y - {y}_{n}}{x - {x}_{n}} ) , & x > {x}_{n} \\ π + {tan}^{- 1} ( \frac{y - {y}_{n}}{x - {x}_{n}} ) , & x \leq {x}_{n}\end{matrix}$ |
| | xₘᵢₙ < x < xₘₐₓ yₘᵢₙ < y < yₘₐₓ zₘᵢₙ < z < zₘₐₓ | ${ϕ}_{n} = \frac{π}{2} + {cot}^{- 1} ( \frac{z - {z}_{n}}{\sqrt{{( x - {x}_{n} )}^{2} + {( y - {y}_{n} )}^{2}}} )$ |

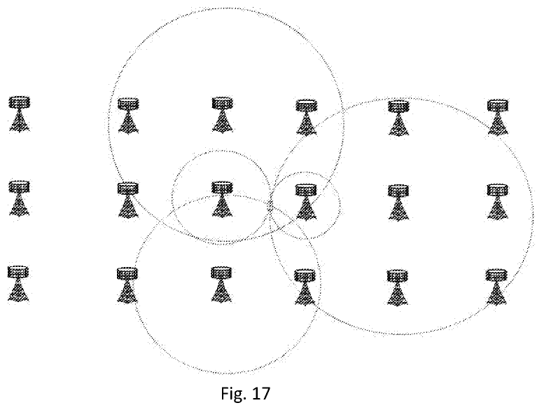

are erroneous due to one or multiple reasons such a receiver's capabilities, state of the link (LoS/NLoS) or UEs mobility. These measurements often result in the degradation in the quality of estimates. Many of these estimates are filtered out based on assistance information from transmitter and receiver. However, some of the measurements are left unchecked and create outliers while computing the position of the target UE. These outliers can be rejected at the server based on Gauss-Newton method. This method looks for measurements which does not satisfy the optimizations objective. It selects a small subset of measurements and computes the co-ordinates that satisfy them with sufficiently small error. In case, the error is large then other subset is selected. Based on the selected subset the mean value of the estimated co-ordinates and variance of estimated co-ordinates in defined. The rest of the measurements are tested on this hypothesis. The measurements which lies outside the threshold percentiles are dropped and the ones that lies within the threshold percentile are included in the subset. The optimization error for the selected subset is computed and the procedure is repeated multiple times to avoid local optima. The subset with the lowest optimization error is chosen for estimating the position. The mean value of the best hypothesis can also be taken as the estimated position and variance can be taken as the uncertainty of the estimates. FIG. 17 illustrates detection of anomalous or outlier measurements.

In one embodiment, The ToA methods schemes yield a better performance for position estimates in horizontal direction compared to AoA and AoD based methods, however for vertical direction angle-based schemes outperforms ToA based methods. The hybrid positioning methods combines the information both time and angle information and often outperform the schemes using time or angle information alone. In this section we propose a multi-objective optimization-based hybrid positioning method. Table 8 illustrates the objective of the hybrid positioning methods.

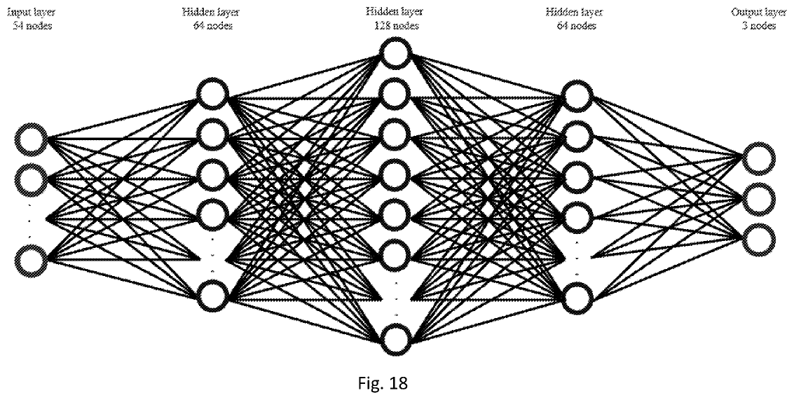

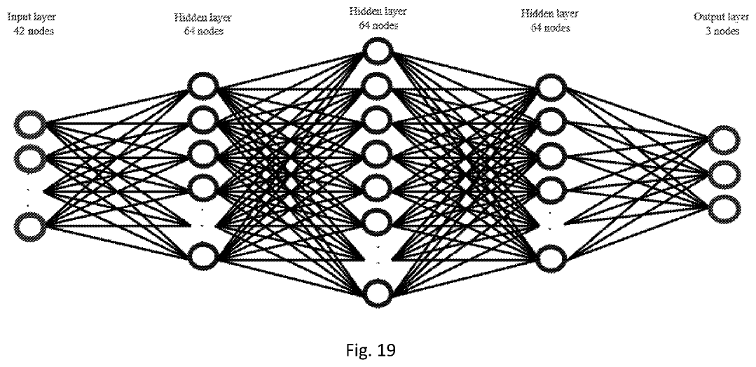

The above optimization problem is solved using gradient descent and Newton Raphson. The hybrid positioning based on multi-objective convex and non-convex optimization methods has a high complexity due to 2 matrix inverses per iteration per epoch in Newton Raphson method. It requires 100-10000 iteration/epoch for these algorithms to converge. The gradient descent does not require any matrix inverse but require an order high number of iterations for convergence. A simpler algorithm based on imitation learning is proposed which require at least 2 order lower complexity for estimating the location of the target UE based on TOA, AOA and AOD from multiple base stations. FIG. 18 illustrates neural network architecture for Hybrid positioning based on imitation learning using 18 BSs. It requires 3 hidden layers with 64, 128 and 64 number of nodes for each layer respectively to estimate (x, y, z) at the output layer with 3 nodes and 56 nodes taking [TOAs, AOAs, AODs] as input from 18 BSs. The neural network is trained for all the possible locations (xₜ, yₜ, zₜ) with a granularity of 0.0001 and their corresponding [TOAs, AOAs, AODs]C^{56×1} are passed as inputs to neural networks for training. The neural network is trained to yield an accuracy up to 10⁻¹⁰ m on validation set. The neural network inputs are be normalized because azimuth and elevation angles take values in [−180, 180] and [−90, 90] respectively and time of arrival takes values in interval [0,4*inter_site_distance/speed of light]. Hence the values are normalized with respect to the maximum value of their intervals. FIG. 19 illustrates neural network architecture for hybrid positioning based on imitation learning using 12 BSs.

In another embodiment, a method of training an Artificial Neural Network (ANN) for positioning a node is proposed. A location of a UE may be generated. Values of at least one positioning parameter may be calculated for the UE, with respect to a base station known location. The location of base station and the calculated values of at least one positioning parameters may be preprocessed for training the ANN. The preprocessed location of the base station and the preprocessed at least one positioning parameters may be input into the ANN. The ANN may learn mapping between all possible locations of the UE, the preprocessed location of the base station location, and the preprocessed at least one positioning parameters. The ANN may be capable of estimating location of the UE.

Another method is proposed where the neural network is trained for a set of 7 BS with their TOAs, AoAs, AoDs with respect to the target UE and location of the BSs as input and location of the target UE as the output with a 10⁻⁵ m granuality. In this case also the input values are normalized with respect to the maximum and minimum values of their range.

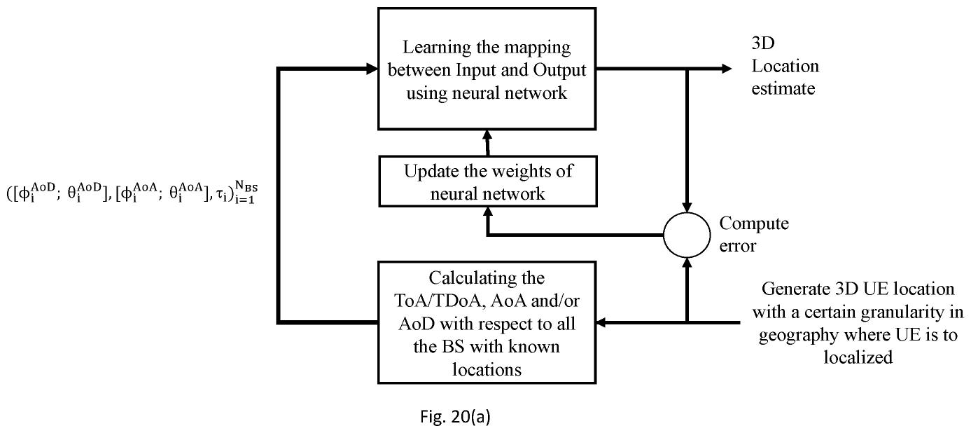

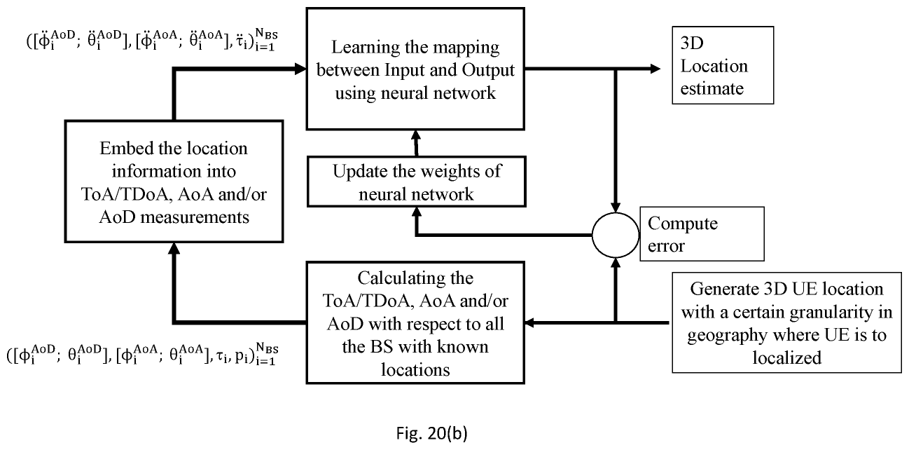

FIG. 20(a) illustrates hybrid positioning method 1 and FIG. 20(b) illustrates hybrid positioning method 2.

In another embodiment, positioning may be done by beam optimization. The accuracy of angle-based positioning depends on the granularity of beam sweeping. The server/BS generates a RSRP vs (AoD and/or AoA) profile using the measurements and configurations reported by UEs and BSs, respectively. The granularity of this power-angle profile depends on granularity of beam sweeping. Higher granularities pose a huge transmission and measurement overhead, in turn the higher latencies. One way to reduce the measurement space is based on the prior power-angular profile information available at the BS based on measurements performed on other reference signals. BS maintains two functions for reducing the measurement space and tracking the UE. These functions are termed value function and policy function. Policy function, □(i), defines the probability that a UE lies in a certain direction with respect to the BS. On the other hand, value function denotes the probability of transition from one direction to another. In simpler terms, policy function describes the probability that a UE will be served by a certain beam-ID and value function v(i, j) describes the probability that beam-j is the next tx-beam for a UE if that UE is currently being served by beam-i. Table 9 illustrates computation of the policy and value functions. The policy function is used to transmit more beams in a direction where there is a higher probability of finding the UE with finer granularity. The value function helps in beam switching. This method helps in reducing the transmission, measurement, and reporting overhead which in turn reduces the latency and power consumption.

| | |
|---|---|
| Variables: | N = 0. |
| | π(i) = 0, ∀i. |
| | v(i, j) = 0, ∀(i, j) |
| | Nⱼ = 0, ∀j. |

For every beam trigger

```
a. N = N + 1; \\ number of beam triggers.
b. k = i; \\ current serving beam.
c. i = bestBeam − ID.
d. π(i) = π(i) +1/N.
e. For ∀j ≠ i && π(j) ≠ 0:
        a. π(j) = π(j) − 1/(N*(card(π)−1)).
f. If j is not NaN:
        a. v(k,i) = v(k,i) + 1/N;
        b. for ∀j ≠ i && π(j) ≠ 0:
              i. Nⱼ = Nⱼ + 1;
              ii. v(k,j) = v(k,j) − 1/(Nⱼ *
                  (card(v(k, : )) − 1));
```

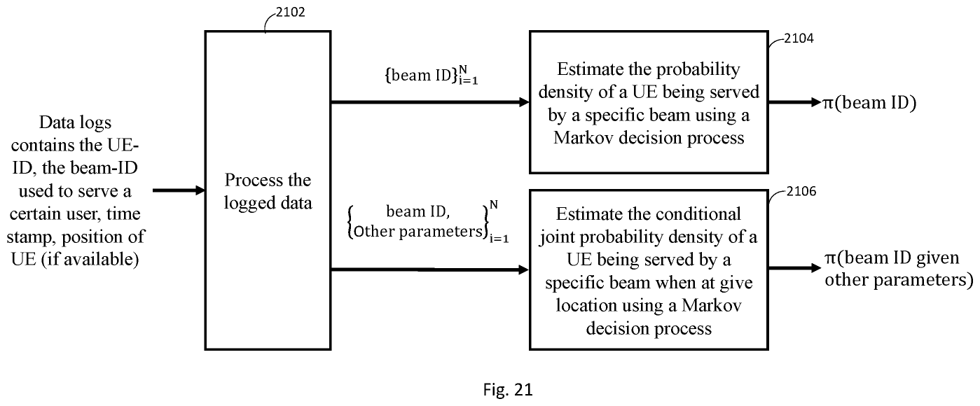

FIG. 21 illustrates a method of learning probability density of a user served by a specific beam. At step 2102, a base station processes a data logs containing one or more of Identification of a User Equipment (UE-ID), a transmitter beam-ID serving a user, a receiver beam-ID, a time stamp and orientation of a User Equipment (UE). At step 2104, the base station estimated probability density of the UE being served by a specific beam using a Markov decision process. The BS generates a policy function based on a probability that the UE lies in a particular direction with respect to the BS and the UE is served by a specific beam. At step 2106, the BS estimates a conditional joint probability density of the UE being served by the specific beam at a given location using a Markov decision process or a Q-neural network, and the policy function based on the specific beam and a one or more positioning parameters. The policy function learns the probability density of the UE being served by a specific beam. The base station may utilize the policy function for transmission of more beams in a direction where there is a higher probability of finding the UE with a fine granularity. The policy function may be updated based on the feedback provided by the UE. The feedback provided may be at least one of a Reference Signal Received Power (RSRP), Signal to Noise Ratio (SNR), Signal to Interference plus Noise Ratio (SINR), Reference Signal Received Quality (RSRQ), and error in values of at least one positioning parameter.

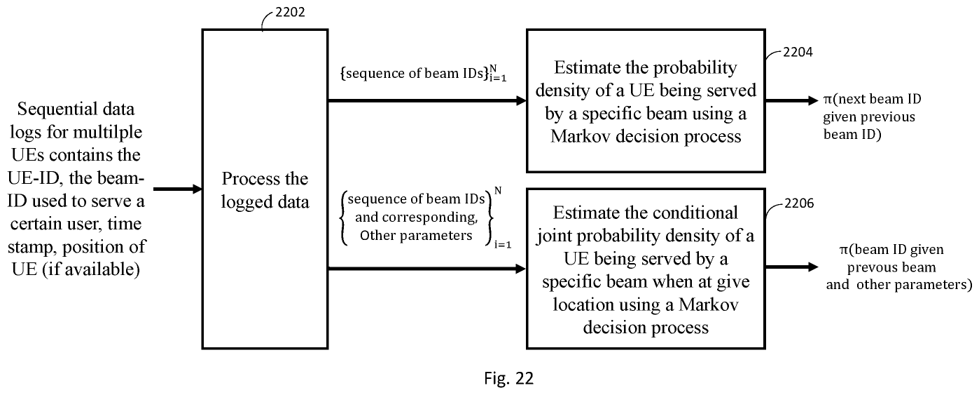

FIG. 22 illustrates a method of learning probability density of a user transitioning from one beam to another. At step 2202, the base station processes a sequential data logs for one or more User Equipment (UEs) containing one or more of Identification of a User Equipment (UE-ID), beam-ID serving a user, time stamp and position of a UE. At step 2204, the base station estimates the probability density of the UE being served by a specific beam using a Markov decision process or a Q-neural network and generates a value function based on a probability of transition from one beam serving the UE to another beam for serving the UE. At step 2206, the base station estimates a conditional joint probability density of the UE being served by the specific beam at a given location using a Markov decision process and generates the value function based on the specific beam and a one or more positioning parameters. The value function learns the probability density of a UE being served by a beam transitioning to another beam for service and the base station utilizes the value function for beam switching. The value function may be updated based on the feedback provided by the UE. The feedback provided may be at least one of a Reference Signal Received Power (RSRP), Signal to Noise Ratio (SNR), Signal to Interference plus Noise Ratio (SINR), Reference Signal Received Quality (RSRQ), and error in values of at least one positioning parameter.

The positioning parameters comprise time positioning parameters including Time of Arrival (ToA) and transmitter-receiver time difference of arrival, and angle positioning parameters including Angle of Arrival (AoA), Angle of Departure (AoD), and Doppler of at least one of first arrival path and additional.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

1. A method for positioning a node in a cellular network, the method comprising:
receiving, by a positioning server, a request for positioning the node from one of the node, a positioning application, and an Access and Mobility Function (AMF);
configuring, by the positioning server, a positioning method;
allocating, by at least one first node, time-frequency resources for reporting at least one positioning parameter for at least one path of a channel based on the positioning method;
transmitting, by the at least one first node, at least one Reference Signal (RS) on an antenna beam;
receiving, by at least one second node, the at least one RS transmitted from the at least one first node;
estimating, by the at least one second node, a value of at least one positioning parameter for the at least one path of the channel; and
reporting, by the at least one second node, estimated values of the at least one positioning parameter to at least one of the positioning server and the at least one first node in the network,
wherein at least one of the positioning server or the at least one first node receives assistance information and additional information reported by the at least one first node and the at least one second node, thereby positioning the node using the at least one positioning parameters, assistance information, and additional information.

2. The method as claimed in claim 1, wherein the at least one positioning parameter comprises time positioning parameters and angle positioning parameters, and wherein the time positioning parameters comprises Time of Arrival (ToA) and transmitter-receiver time difference of arrival, and the angle positioning parameters include Angle of Arrival (AoA), Angle of Departure (AoD), and Doppler of at least one of a first arrival path and additional paths.

3. The method as claimed in claim 1 through claim 2, wherein performing the estimation of the at least one positioning parameter further comprises:
estimating, by the at least one second node, a Channel State Information (CSI) based on at least one antenna of a plurality of antennas present at the at least one second node, number of subcarriers, and number of Orthogonal Frequency Division Multiplexing (OFDM) symbols across time;
interpolating, by the at least one second node, the channel at one of the at least one resource element across frequency and at least one resource element across time, where none of the at least one RS is transmitted; and
estimating, by the at least one second node, the value of at least one positioning parameter, for at least one of the multiple paths of the channel.

4. The method as claimed in claim 1 through claim 3, wherein two or more positioning parameters are jointly estimated using any one of Estimation of Signal Parameters via Rational Invariance Techniques (ESPRIT) or Multiple Signal Classification (MUSIC) algorithms based on a re-dimensioned CSI determined using estimated CSI matrix obtained by reducing one of a dimension comprising of time, frequency and space.

5. The method as claimed in claim 1, wherein during the estimation of the at least one positioning parameter individually, the node in the cellular network, further performs:
calculating a Fourier delay matrix for delay of the at least one path of the channel;
computing a steering angle matrix for all possible pairs of at least one angle positioning parameter including AoA and AoD;
computing, an association matrix through a modulus function of a product obtained by pre-multiplication of the steering angle matrix with a time domain re-dimensioned CSI matrix and post multiplication of the product obtained with the Fourier delay matrix; and
computing, a mapping matrix based on a dominant absolute element of the association matrix, for establishing a unique association between a time positioning parameter (ToA) and the at least one angle positioning parameter including AoA and AoD,
wherein the time positioning parameter (ToA) and the at least one angle positioning parameter are paired based on the estimated associations.

6. The method as claimed in claim 5, wherein the node is one of the first node, the second node, and the positioning server, at which CSI is available for the estimation at least one of the positioning parameters.

7. The method as claimed in claim 4, wherein while performing the estimation of the at least one positioning parameter individually, the node further performs:
transforming the estimated CSI into time-domain estimated CSI using an inverse two-dimensional Fourier transformation;
selecting a closest time indices in time domain estimated CSI corresponding to the time positioning parameter (ToA);
computing a steering matrix for all possible pairs of the at least one angle positioning parameter including AoA and AoD;
computing an association matrix through pre-multiplication of the absolute value of the time domain estimated CSI with the steering angle matrix; and
computing a mapping matrix based on a dominant absolute element of the association matrix, for establishing a unique association between the time positioning parameter (ToA) and the at least one angle positioning parameter including AoA and AoD,
wherein the time positioning parameter (ToA) and the at least one angle positioning parameter are paired based on the estimated associations.

8. The method as claimed in claim 1 through claim 7, wherein the computing of the mapping matrix further includes iteratively selecting a largest element of association matrix and setting corresponding indices of the largest element in the mapping matrix to one, and wherein the largest element is selected when any element in a row or a column of the mapping matrix is not already set to one, and the largest element is skipped for selection of the next largest element when any element in the row or the column of the mapping matrix is already set to one.

9. The method as claimed in claim 1 through claim 8, wherein the first node and the second node are one of the base station, a user equipment, the positioning server, relay node, vehicle-to-everything (V2X) node, transmission reception points (TRP), and repeaters in the cellular network.

10. A method for positioning a node in a cellular network, the method comprising:
transmitting, by at least one first node, a reference signal (RS) beamformed on at least one antenna beam;
reporting by the at least one first node, a direction in which the at least one antenna beam is transmitted to a destination node;
estimating, by the at least one second node, delay in at least one path of a channel and a corresponding path-power for each of the at least one antenna beam, based on the RS;
reporting, by the at least one second node, the path delay and the corresponding path-power for each of the at least one antenna beam to the destination node;
selecting, by the destination node, at least one antenna beam with a lowest value of first arrival path delay; and
determining, by the destination node, the at least one antenna beam with lowest value of the first arrival path delay.

11. The method as claimed in claim 10, wherein when the at least one antenna beam with lowest value of the first arrival path delay is determined to be one, the ToA is a first arrival path delay, AoD is a beam angle, and the path power is a path power, of the selected antenna beam.

12. The method as claimed in claim 10, wherein when the at least one antenna beam with lowest value of the first arrival path is determined to be more than one, an antenna beam with highest path power from the beams with lowest values of the first arrival path is selected, wherein ToA is the first arrival path delay, AoD is the beam angle, and the first path power is the path power, of the selected antenna beam.

13. The method as claimed in claim 10 through claim 11, wherein when the number of antenna beams with lowest value of the first arrival path are determined to be more than one, a weighted average of the number of the antenna beams is used for ToA, AoD and first path power selection, wherein the ToA is weighted average of the first arrival path delays, the AoD is weighted average of beam angles, and the first path power is weighted average of the path powers of the antenna beams.

14. The method as claimed in claim 10 through claim 13, wherein the destination node is one of a positioning server, user equipment, base station, relay node, V2X node, repeater, the first node, and the second node, in a cellular network.

15. The method as claimed in claim 10 through claim 14, wherein the first node and the second node are one of a base station, user equipment, positioning server, relay node, vehicle-to-everything (V2X) node, transmission reception points (TRP), and repeaters in the cellular network.

16. A method for positioning a node in a cellular network, the method comprising:
estimating, by at least one second node, a channel based on an at least one reference signal (RS) transmitted on at least one beam by at least one first node;
interpolating, by the at least one second node, the channel belonging to each of the at least one beam to obtain a channel for at least one adjacent time-frequency resources where the RS is not transmitted;
computing, by the at least one second node, a power delay profile (PDP) of the channel; and
recording, by the at least one second node, locations of at least one peak in the PDP,
wherein the at least one second node reports a delay and a path power corresponding to the one or more computed peaks in the PDP, to a destination node.

17. The method as claimed in claim 16, wherein computing the PDP of the channel further comprises interpolating, by the at least one second node, the PDP around each of the at least one peak based on adjacent taps in the PDP and based on entire PDP, wherein the at least one second node determines values and the locations of the at least one peak in the PDP.

18. The method as claimed in claim 16 through claim 17, wherein the at least one second node determines and reports the value of at least one of a path delay and a path power of a first highest peak in the PDP, wherein the path delay of the first highest peak is Time of Arrival (ToA).

19. The method as claimed in claim 16 through claim 17, wherein the at least one second node determines and reports the value of at least one of a path delay and a path power of at least one peak in the PDP.

20. The method as claimed in claim 16 through claim 19, wherein the at least one second node interpolates the channel at a location of at least one path delay for estimation of at least one angle positioning parameters, wherein the at least one second node determines and reports the value of at least one of the path delay, the path power of at least one peak in the PDP and the at least one angle positioning parameter to the destination node, and wherein the at least one angle positioning parameter includes Angle of Arrival (AoA) and Angle of Departure (AoD).

21. The method as claimed in claim 16 through claim 20, wherein the destination node is one of a positioning server, user equipment, base station, relay node, V2X node, repeater, the first node, or at least one of the second nodes, in the cellular network.

22. The method as claimed in claim 16 through claim 21, wherein the first node and the second node are one of a base station, user equipment, positioning server, relay node, vehicle-to-everything (V2X) node, transmission reception points (TRP), or repeaters in a cellular network.

23. A method for estimation of a channel in a cellular network, the method comprising:
transmitting, by at least one first node, at least one Reference Signal (RS);
receiving, by at least one second node, multiple adjacent frequency layers across any of same time slot or different time slots;
aggregating, by the at least one second node, the at least one RS across the multiple adjacent frequency layers for estimation of a channel;
estimating, by the at least one second node, the channel based on at least one RS aggregated over the multiple adjacent frequency layers;
interpolating the channel on resource elements in at least one frequency layer where none of the at least one RS is transmitted and performing smoothing of the channel over at least one frequency layer; and
extrapolating the channel in a frequency domain in outer resource elements,
wherein the at least one frequency layer is predicted using a Long short-term memory (LSTM) Recurrent Neural Network (RNN).

24. The method as claimed in claim 23, wherein a contiguous frequency band channel is utilized for estimation of one or more positioning parameters by at least one of the first node, the second node or a positioning server.

25. The method as claimed in claim 23, wherein the one or more positioning parameters comprise time positioning parameters and angle positioning parameters, the time positioning parameters include Time of Arrival (ToA) and transmitter-receiver time difference of arrival, and the angle positioning parameters include Angle of Arrival (AoA), Angle of Departure (AoD), and Doppler of at least one of a first arrival path and additional paths.

26. A method for positioning a node in a cellular network, the method comprising:
configuring, by at least one positioning server, a positioning method and assistance information for LoS confidence detection;
allocating, by at least one first node, time-frequency resources for reporting at least one positioning parameter for at least one path of multiple channel paths based on the positioning method;
transmitting, by the at least one first node, at least one reference signal on at least one beam;
estimating, by at least one second node, a path delay and angle positioning parameters for the multiple channel paths, wherein the angle positioning parameters include Angle of Arrival (AoA) and Angle of Departure (AoD); and
selecting, by the at least one second node, a path with a minimum value of the path delay as a first arrival path and a corresponding value of at least one of the angle positioning parameters for positioning a node as the value of AoA and AoD of the first arrival path, wherein the first arrival path is a Line of Sight (LoS) path,
wherein the at least one second node reports values of the path delay, the at least one angle positioning parameters, and the LoS confidence parameter of each of the multiple channel paths to a destination node.

27. The method as claimed in claim 26, wherein the LoS confidence parameter is determined using a misalignment angle between the at least one second node and the at least one first node, and wherein the misalignment angle is an angle offset between the AoD and the AoA of one path of the multiple channel paths.

28. The method as claimed in claim 26, wherein the destination node further performs:
determining a link as LoS or NLOS using LoS confidence parameter, wherein the link is determined as NLoS when the LoS confidence parameter is present below a threshold value, and determined as LoS when the LoS confidence parameter is present above the threshold value; and
estimating an NLOS bias per path based on a location of a reflector,
wherein the destination node corrects and updates values of at least one of the time positioning parameters and the angle positioning parameters based on the NLOS bias, thereby positioning a node using updated values.

29. The method as claimed in claim 26 through claim 28, wherein the first node, the second node, and the reference node are one of the base station, a user equipment, the positioning server, relay node, vehicle-to-everything (V2X) node, transmission reception points (TRP), or repeaters, in a cellular network.

30. The method as claimed in claim 26 through claim 29, wherein the destination node is one of the positioning server, first node, and the second node.

31. The method as claimed in claims 26 through claim 30, wherein the LoS confidence parameter is one of a one bit value and soft value between zero to one, and wherein a value one indicates the link as LoS and value zero indicates the link as NLoS.

32. A method for calibration of antenna, clock, and hardware in a cellular network, the method comprising:
configuring, by a positioning server, at least one Positioning Reference Node (PRN) with at least one positioning method;
allocating, by at least one first node, time-frequency resources for reporting at least one positioning parameters for at least one path of multiple channel paths based on the positioning method;
transmitting, by the at least one first node, at least one reference signal on a beam to at least one PRN;
receiving, by the at least one PRN, at least one reference signal on allocated time-frequency resources transmitted by the at least one first node;
estimating, by the at least one PRN, values of at least one positioning parameter;
computing, by the at least one PRN, actual values of the at least one positioning parameter with respect to own location; and
reporting by the at least one PRN, an estimated value and the actual value of at least one positioning parameter to a destination node,
wherein the destination node calculates an angle offset and a time offset based on an error between the actual value and estimated value of the at least one positioning parameters.

33. The method as claimed in claim 32, wherein the angle offset and the time offset are one of instantaneous value and average value.

34. The method as claimed in claim 32 through claim 33, wherein the destination node provides the angle offset and the time offset as assistance information to a node, thereby correcting the at least one positioning parameters measured in the node using the error calculated between the actual values and the estimated values of the at least one positioning parameters.

35. The method as claimed in claim 32 through claim 34, wherein the first node and the second node are one of the base station, a user equipment, the positioning server, relay node, vehicle-to-everything (V2X) node, transmission reception points (TRP), and repeaters, in the cellular network.

36. The method as claimed in claim 32 through claim 35, wherein the destination node is one of the positioning server, the first node and the second node.

37. The method as claimed in claim 32 through claim 36, wherein the one or more positioning parameter comprises time positioning parameters and angle positioning parameters, the time positioning parameters include Time of Arrival (ToA) and transmitter-receiver time difference of arrival, and the angle positioning parameters include Angle of Arrival (AoA), Angle of Departure (AoD), and Doppler of at least one of a first arrival path and additional paths.

38. A method of training an Artificial Neural Network (ANN) for positioning a node, the method comprising:
generating a location of at least one first node;
calculating values of at least one positioning parameter, for the at least one first node, with respect to at least one second node with known location;
preprocessing the location of at least one second node and the calculated values of the at least one positioning parameter for training the ANN;
inputting the preprocessed location of at least one second node location and the preprocessed at least one positioning parameter into the ANN; and
learning, by the ANN, mapping between all possible locations of the at least one first node, the preprocessed location of the at least one second node location, and the preprocessed at least one positioning parameters, wherein the ANN is capable of estimating location of the at least first node in the wireless network.

39. The method as claimed in claim 38, wherein the preprocessing includes maintaining unique one to one mapping between an input and an output, and number of outputs is equal to number of at least one second node.

40. The method as claimed in claim 38, wherein the at least one positioning parameter for at least one path includes Time of Arrival (ToA), Angle of Arrival (AoA), Angle of Departure (AoD), and Doppler.

41. A method of beam prediction in a cellular network, the method comprising:
processing, by at least one second node, data logs containing at least one of identity of at least one first node (FN-ID), a transmitter beam ID, a receiver beam ID, orientation of the at least one first node, a time stamp, and a position of the first node;
learning, by the at least one second node, a policy function;
computing, by the at least one second node, a conditional joint probability density of the at least one first node being served by the specific beam at a given location, conditioned on the at least one first node (FN-ID), transmitter beam ID, receiver beam ID, orientation of the at least one first node, the time stamp, and the position of the first node, using the leaned policy function; and
selecting, by the at least one second node, at least one beam for transmitting at least one reference signal,
wherein the policy function is updated based on the feedback provided by the at least one first node.

42. The method as claimed in claim 41, wherein the policy function is updated based on a probability density of presence of the at least one first node in a particular direction with respect to the at least one second node and the at least one first node being served by a specific beam, using a Markov decision process or Q-neural networks (QNN).

43. The method as claimed in claim 41 through claim 42, wherein the feedback provided is at least one of a Reference Signal Received Power (RSRP), Signal to Noise Ratio (SNR), Signal to Interference plus Noise Ratio (SINR), Reference Signal Received Quality (RSRQ), reference signal strength indicator (RSSI), and error in values of at least one positioning parameter.

44. The method as claimed in claim 41, wherein the at least one positioning parameter comprises one or more time positioning parameters including Time of Arrival (ToA) and transmitter-receiver time difference of arrival, and one or more angle positioning parameters including Angle of Arrival (AoA), Angle of Departure (AoD), and Doppler of at least one of first arrival path and additional paths

45. The method as claimed in claim 41 through claim 44, wherein the first node and the second node includes a base station, a user equipment, the positioning server, relay node, vehicle-to-everything (V2X) node, transmission reception points (TRP), and repeaters, in a cellular network.

46. A method for beam tracking in a wireless communication system, the method comprising:
processing, by at least one second node, sequential data logs for at least one of identity of at least one first node (FN-ID), a beam ID serving the at least one first node, a time stamp, and a position of the first node;
learning, by the at least one second node, a value function;
computing, by the at least one second node, a conditional probability of the next beam given that at least one current beam of the first node, at least one of FN-ID, a beam-ID of the at least one second node, beam-ID of the at least one first node, orientation of the at least one first node, the time stamp, and position of the at least one first node using the learned value function; and
selecting, the at least one next beam for transmitting a reference signal,
wherein the value function is updated based on the feedback provided by the at least one first node.

47. The method as claimed in claim 46, wherein the value function is a probability of the at least one first node being served by a next beam for a current beam, using one of Markov decision process or Q-neural networks (QNN).

48. The method as claimed in claim 46 through claim 47, wherein the feedback provided includes at least one of a Reference Signal Received Power (RSRP), Signal to Noise Ratio (SNR), Signal to Interference plus Noise Ratio (SINR), Reference Signal Received Quality (RSRQ), reference signal strength indicator (RSSI), and error in values of at least one positioning parameter.

49. The method as claimed in claim 46 through claim 48, wherein the one or more positioning parameters comprise one or more time positioning parameters including Time of Arrival (ToA) and transmitter-receiver time difference of arrival, and one or more angle positioning parameters including Angle of Arrival (AoA), Angle of Departure (AoD), and Doppler of at least one of first arrival path and additional paths

50. The method as claimed in claim 46 though claim 49, wherein the at least one first node and the at least one second node includes a base station, a user equipment, the positioning server, relay node, vehicle-to-everything (V2X) node, transmission reception points (TRP), and repeaters, in a cellular network.
